(19) United States
(12) Patent Application Publication
(10) Pub. No.: US 2004/0088232 A1
(43) Pub. Date: May 6, 2004

(54) Method for tracking transactions in a not-for-profit accounting system

(76) Inventor: Raymond A. Minnis JR., Charleston, SC (US)

Correspondence Address: Jack D. Todd, Esq., Morris, Manning & Martin, LLP, 3343 Peachtree Road, N.E., Atlanta, GA, 30326-1044, US

(21) Appl. No.: 10/696,439

(22) Filed: Oct. 29, 2003

Related U.S. Application Data
(60) Provisional application No. 60/421,954, filed on Oct. 29, 2002.

(51) Int. Cl. G06F 17/60

(52) U.S. Cl. 705/30

(57) ABSTRACT

In a computerized accounting system, a method of tracking and analyzing financial transaction information associated with accounts, without the need for addition account segments to define the account number of each account, includes defining at least one transaction code, each transaction code having a plurality of permissible values, receiving a transaction having an amount and being associated with an account, and associating the transaction with a project and with a value from the plurality of permissible values for the at least one transaction code. Another method includes subdividing the total amount of the transaction into two or more portions, each portion being associated with a project and with respective values of the permissible values for a plurality of transaction codes. Use of the transaction codes results in improved reporting and enhanced data analysis.

### CROSS REFERENCE TO RELATED APPLICATION

This application claims the benefit under 35 U.S.C. § 119(e) of U.S. provisional patent application No. 60/421,954, entitled “System and Method for Creating Financial Transaction Tracking for Nonprofit Organizations,” filed Oct. 29, 2002, which is incorporated herein by reference.

### FIELD OF THE PRESENT INVENTION

The present invention relates generally to financial and accounting software and, more particularly, to methods and systems for multidimensional analysis and tracking of transactions in not-for-profit accounting systems.

### BACKGROUND OF THE PRESENT INVENTION

Accounting principles, tax issues, and reporting requirements for non-profit or not-for-profit organizations (hereinafter “not-for-profit organizations” or “not-for-profits”) are substantially different from those applicable to commercial enterprises. For example, commercial enterprises typically measure product, brand, division, and company performance on a profit/loss basis. In contrast, not-for-profit organizations not only measure incoming and outgoing funds, but they must also document that they are spending and using money wisely, efficiently, in accordance with their own charter, and in accordance with the specific restrictions placed on donations they receive.

Not-for-profits must keep a formal budget as part of the organization's books; track and report accounting records separately for different funding sources, grants, departments, scholarships, programs, or functions; be able to allocate expenses across different funding sources, grants, departments, scholarships, programs, or functions; track and report across diverse time periods, sometimes spanning multiple years and on a non-annual basis; keep funds separate, according to donor restrictions; measure the success of fund raising events, programs, and departments; track efficiency of the organization using the ratio of overhead to program usage; and produce specialized reports for different internal and external audiences.

Because of these obligations, not-for-profit organizations need accounting systems that are more robust and versatile than conventional accounting system used by commercial enterprises or individuals. In particular, accounting systems for not-for-profit organizations must have the ability to generate numerous financial statements and reports for this diverse audience. Not only must not-for-profits comply with the stringent reporting standards of the Financial and Governmental Accounting Standards Boards (FASB & GASB), but they must also respond to requests from private and public granting agencies that require detailed, customized reports, and they must be able to generate reports for their own internal uses—such as review by the Board of Directors or by a particular fund or project manager.

Many accounting software packages currently exist that provide not-for-profit organizations with a means for tracking financial data and for creating financial reporting documents. These software packages, however, have historically tracked financial data by relying on account numbers and, increasingly, account numbers that are becoming increasingly more complex. Typically, such account numbers are divided into a plurality of account segments, wherein, each account segment provides additional information about the account, such as which department it belongs to, its project, its mission, its location, and its region. Because not-for-profit organizations receive restricted funding that requires an accurate accounting for both the sources and uses of those restricted funds, users must enter segment values for each restricted funding source. As new funding sources are added to a system, a new and complete series of accounts must also be created. The chart of accounts used by an organization and managed by the accounting system will continue to grow over time to a point where many accounting software users find their system increasingly difficult to use. For example, if “Organization X” receives 50 grants per year from various funding sources, “Organization X” must create complete series of revenue and expense accounts for all 50 grants.

More specifically, a conventional account may be described in a format such as 01-1071-03-02-001, wherein 01 represents a fund, 1071 represents an account code, 03 represents a department, 02 represents a project, and 001 represents a particular mission. If there are three possible funds, one hundred different account codes, five different departments, ten different projects, and twenty different missions, then there are 300,000 possible account numbers that the system must track. Further, if the system user needs to add one more project, then the system must track another 15,000 unique account numbers; if the system user needs to add one more mission, then the system must track another 30,000 unique account numbers; and if the system user needs to add another segment of differentiation that has two possibilities, then the system must track another 300,000 unique account numbers. Obviously, this procedure for tracking financial data can become quite cumbersome and unusable.

Further, many restricted funding sources are given to address a specific need or purpose. As grants end, not-for-profit organizations must mark those accounts pertaining to a completed grant as inactive. Many organizations are left with numerous inactive accounts that increase the likelihood for mistakes-that is, data entry staff may post current activity to inactive accounts causing reports to be inaccurate.

In addition, reporting on restricted contributions in most systems must be performed in a reporting module or using a report writer. A user must enter a report writer and possibly design a new report prior to any useful information regarding the use of a particular restricted gift.

For these and many other reasons, there is a need for a system and methods for enabling organizations to track and analyze financial data without increasing the number of accounts being tracked by the system, without requiring use of more account segments, and without increasing the number of accounts in the organization's chart of accounts.

There is a further need for a system and methods that enable organizations to track and report on all of the information available in systems that use multiple account segments without the corresponding complexity.

There is a need for a system and methods for enabling an organization to reduce the number of inactive accounts maintained by the accounting system.

There is a need for a system and methods that enables tracking and analysis of account-related data, such as projects, location, region, and mission, using textual descriptions rather than numeric segment values.

There is a need for a system and method for enabling organizations to track and analyze financial data in a multidimensional manner.

There is a need for a system and methods for reporting on a single account with filtering to show all or some account-related data, such as projects, location, region, and mission.

For these and many other reasons, there is a general need for, in a computerized accounting system having a plurality of accounts associated therewith, each account having one or more account segments defining an account number, an improved method of tracking transactional information associated with accounts without the need for adding further account segments to the accounts, comprising the steps of defining at least one transaction code, the transaction code having a plurality of permissible values associated therewith, receiving an input defining a transaction, the transaction having an amount, associating the transaction with one of the plurality of accounts, associating the transaction with a project, associating the transaction with the at least one transaction code, and assigning a value from the plurality of permissible values to the at least one transaction code.

For these and many other reasons, there is a general need for, in a computerized accounting system having a plurality of accounts associated therewith, each account having one or more account segments defining an account number, an improved method of tracking transactional information associated with accounts without the need for adding further account segments to the accounts, comprising the steps of receiving an input defining a transaction, the transaction having an amount, associating the transaction with one of the plurality of accounts, for at least two portions of the amount: (i) associating each respective portion with a plurality of transaction codes and (ii) assigning a value to each transaction code.

The present invention meets one or more of the above-referenced needs as described herein in greater detail.

### SUMMARY OF THE PRESENT INVENTION

The present invention relates generally to financial and accounting software and, more particularly, to methods and systems for multidimensional analysis and tracking of transactions in not-for-profit accounting systems. Briefly described, aspects of the present invention include the following.

In a first aspect of the present invention, in a computerized accounting system having a plurality of accounts associated therewith, each account having one or more account segments defining an account number, an improved method of tracking transactional information associated with accounts without the need for adding further account segments to the accounts, comprising the steps of defining at least one transaction code, the transaction code having a plurality of permissible values associated therewith, receiving an input defining a transaction, the transaction having an amount, associating the transaction with one of the plurality of accounts, associating the transaction with a project, associating the transaction with the at least one transaction code, and assigning a value from the plurality of permissible values to the at least one transaction code.

In a feature of the first aspect of the invention, the at least one transaction code is definable by a user of the computerized accounting system. In another feature, the at least one transaction code is pre-defined.

In yet another feature, the at least one transaction code represents one of the following types of information: a mission, a region, a department, a location, a performance, or a spendable/non-spendable indicator.

In another feature, at least one of the plurality of permissible values associated with the at least one transaction code is definable by a user of the computerized accounting system. In another feature, at least one of the plurality of permissible values associated with the at least one transaction code is pre-defined.

Preferably, the transaction is or represents a credit or a debit to the relevant account.

Another feature of the first aspect of the invention includes the step of generating a financial report including the transaction, the financial report further including the value of the transaction code.

In a further feature, the transaction is associated with the transaction code and the value of the transaction code is assigned based on the association of the transaction with one of the plurality of accounts.

In a second aspect of the present invention, in a computerized accounting system having a plurality of accounts associated therewith, each account having one or more account segments defining an account number, an improved method of tracking transactional information associated with accounts without the need for adding further account segments to the accounts, comprising the steps of receiving an input defining a transaction, the transaction having an amount, associating the transaction with one of the plurality of accounts, for at least two portions of the amount: (i) associating each respective portion with a plurality of transaction codes and (ii) assigning a value to each transaction code.

In a feature of the second aspect, the method further comprises the step of defining the transaction codes, each transaction code having a plurality of permissible values associated therewith. In a related feature, at least one of the plurality of permissible values associated with at least one transaction code is definable by a user of the computerized accounting system. In another related feature, at least one of the plurality of permissible values associated with at least one transaction code is pre-defined.

Preferably, in the above aspect of the invention, the portions add up to the amount. In some cases, the portions are equal. In a feature of the invention, each portion is associated with the same transaction codes. In a yet further feature, the values assigned to the transaction codes of each portion are different. In another feature, each portion is associated with different transaction codes.

In another feature of the second aspect of the invention, at least one of the transaction codes is definable by a user of the computerized accounting system and, in another feature, at least one of the transaction codes is pre-defined.

In yet another feature, at least one transaction code represents one of the following types of information: a mission, a region, a department, a location, a performance, or a spendable/non-spendable indicator.

Preferably, the transaction is or represents a credit or a debit to the relevant account.

Another feature of the first aspect of the invention includes the step of generating a financial report including the transaction, the financial report further including the portions and the values of the transaction codes associated with the portions.

The present invention also encompasses computer-readable medium having computer-executable instructions for performing methods of the present invention, and computer networks and other systems that implement the methods of the present invention.

The above features as well as additional features and aspects of of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1A is a graphical representation of a series of transactions that must be tracked and categorized by methods and systems of the preferred embodiment of the present invention;

FIG. 1B is a block diagram illustrating two balancing transactions that are being tracked and categorized using methods and systems of the preferred embodiment of the present invention;

FIG. 2 is a screen shot of a main start page of a preferred accounting system for use with the present invention;

FIG. 3 is a screen shot of a main records page of a preferred accounting system for use with the present invention;

FIG. 4 is a screen shot of a main accounts page of a preferred accounting system for use with the present invention;

FIG. 5 is a screen shot of a new account page of a preferred accounting system for use with the present invention;

FIGS. 6A through 6C are screen shots of an account search page of a preferred accounting system for use with the present invention;

FIGS. 7A through 7D are screen shots of a new project page of a preferred accounting system for use with the present invention;

FIG. 8 is a screen shot of a configuration page of a preferred accounting system for use with the present invention;

FIG. 9 is a screen shot of an account structure setup page of a preferred accounting system for use with the present invention;

FIG. 10 is a screen shot of an account category definitions setup page of a preferred accounting system for use with the present invention;

FIG. 11 is a screen shot of an account invalid segment combinations setup page of a preferred accounting system for use with the present invention;

FIG. 12 is a screen shot of an account default descriptions setup page of a preferred accounting system for use with the present invention;

FIG. 13 is a screen shot of a main transaction code setup page of a preferred accounting system for use with the present invention;

FIGS. 14A through 14F are screen shots of transaction code values setup pages of a preferred accounting system for use with the present invention;

FIG. 15 is a screen shot of a main journal entry page of a preferred accounting system for use with present invention;

FIGS. 16A through 16E are screen shots of a new transaction batch showing use of methods and systems of the present invention;

FIG. 17 is a flowchart of a setup methodology associated with the present invention;

FIG. 18 is a flowchart of an implementation methodology associated with the present invention; and

FIG. 19 is an exemplary financial report showing one advantageous use of transaction codes of the present invention.

### DETAILED DESCRIPTION OF PREFERRED EMBODIMENTS

### Account System Terminology

Before turning to the detailed description of the preferred embodiments, it will be helpful to identify a number of standard accounting system definitions and terms that will be used repeatedly herein. These definitions and terms are provided not for purposes of limitation but rather for providing some context for the following description of the invention. The detailed description of the invention that follows may modify or expand the scope of these terms as will become apparent hereinafter.

Account. An account is a tool typically used to group financial transactions posted from the journal entry of an accounting system or from other subsystems of an accounting system, such as accounts payable, accounts receivable, or payroll. Accounts typically show increases, decreases, and an ending balance that provide a means for creating financial statements.

Account category. Accounts in not-for profit accounting systems are typically and currently classified into one of the following account categories: asset, liability, net asset, revenue, expense, gift, transfer, gain, or loss.

Account code. An account code is an account segment portion of an account number. The account code may be used advantageously to indicate in what account category the account number (and hence the account) belongs.

Account class. There are currently three different types of account classes for accounts used by not-for-profit organizations: (i) unrestricted net assets, (ii) temporarily restricted net assets, and (iii) permanently restricted net assets. These three account classes indicate whether and to what extent funds in the account have any restrictions placed upon their use.

Account number. An account number is the alphanumeric representation assigned to or associated with an account. The account number may be divided into a plurality of account segments, each of which may be used advantageously to place the account into different groupings (e.g., by fund, department, project, account category, etc.) for easy sorting, filtering, and reporting purposes.

Account segment. An account segment is preferably a set of digits that make up all or part of the account number. For example, in a preferred embodiment of the present invention, account number 01-11100-00 may be arbitrarily defined to indicate the following: the first set of numbers in this account number is called the “fund segment” because it represents, in this case, that this account is in fund 01, the second set of numbers is called the “account code segment” because these numbers stand for the account code (in this case, 11100), and the third set of numbers is called the “department segment” because it indicates with which department this account is associated. Although not shown in this one example, many other system-defined or user-defined segments could be used to further subgroup and compartmentalize accounts; however, as will be discussed herein, transaction codes may be used advantageously to provide such sub-grouping and compartmentalization without further complicating the chart of accounts used by the system. Finally, it should be readily apparent to one skilled in the art that the mere arrangement of the segments, use and type of separators between segments, if any, and the use of characters or other symbols instead of numbers are arbitrary and are all within the scope of the present invention.

Asset. An asset is property owned by the organization using the accounting system of the present invention. The property may be tangible or intangible and it has a value. Assets are typically recorded at cost on the balance sheet and reduced by depreciation or amortization as their value is used in the course of business operations.

Attribute. An attribute is a tool used to group information based on a common theme. Attributes may be used, for example, to filter or sort information for display or reporting purposes. Typical attributes used in the present invention include the following: accounts, projects, transactions, actions, vendors, purchase orders, invoices, and credit memos.

Chart of accounts. A chart of accounts is a systematic numeric listing of all accounts that exist in an organization's general ledger.

Equity. Equity is the worth of an organization, calculated by subtracting liabilities from assets. In nonprofit organizations, equity is known as “net assets”.

Expense. An expense is the result of using assets in the course of conducting operations. Examples are telephone charges, gasoline purchases, and repairs. Expenses are deducted from revenues on the income statement of financial activities report to arrive at net income or net surplus.

Fund. A fund is a self-balancing set of accounts. Funds separate accounts into groups specific to certain activities, donor-imposed restrictions, or objectives. In the preferred embodiment, funds must be created before accounts can be entered or created.

Gain. A gain is an infrequent or one-time source of revenue, as opposed to revenues derived from an organization's normal activities. An example of a gain is revenue realized from the sale of a vehicle.

General Ledger. A general ledger is the primary financial transaction register in an accounting system that contains all balance sheet and income statement accounts. It is used as a central storage file for all financial transaction records, regardless of whether they are created in related systems, such as an accounts payable program or added as manual journal entry transactions directly into the general ledger.

Gift. A gift typically is revenue from donations.

Loss. A loss is an infrequent expense, for example, a vehicle disposed of prior to the end of its estimated life.

Net asset. A net asset is residual value in an entity's asset remaining after liability is deducted.

Project. A project is a transaction-level identifier that categorizes transactions and budget entries. Projects are used to track equity balances or prepare financial statements for a given purpose.

Record. A record is the primary way information is stored in the present invention. From a record, one can add, edit, and delete collections of information. One record can contain other records. For example, a vendor record usually contains invoices.

Transaction. A transaction is a general ledger entry that indicates to the system the amount and account to debit or credit. Transactions also contain additional information that helps trace and report on them. Transactions include source codes and journal references and, in some embodiments, may include project and transaction code distributions.

Transaction code. A transaction code is an additional field on each transaction that helps further categorize information in reporting and closing fiscal years. In the preferred embodiment, up to five transaction codes, each with its own table of permissible values, can be defined by the user. Because it can retain equity, a transaction code acts like a project. Unlike a project, though, a transaction code does not provide additional functionality, such as budgets, media, or notes.

### System Overview

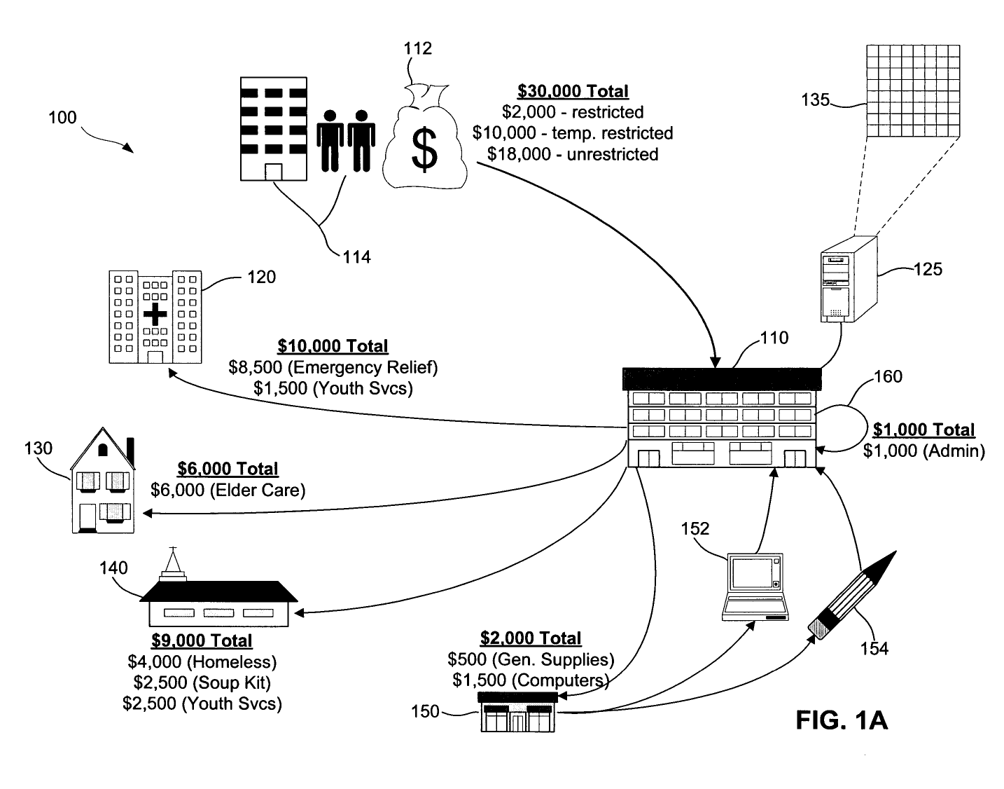

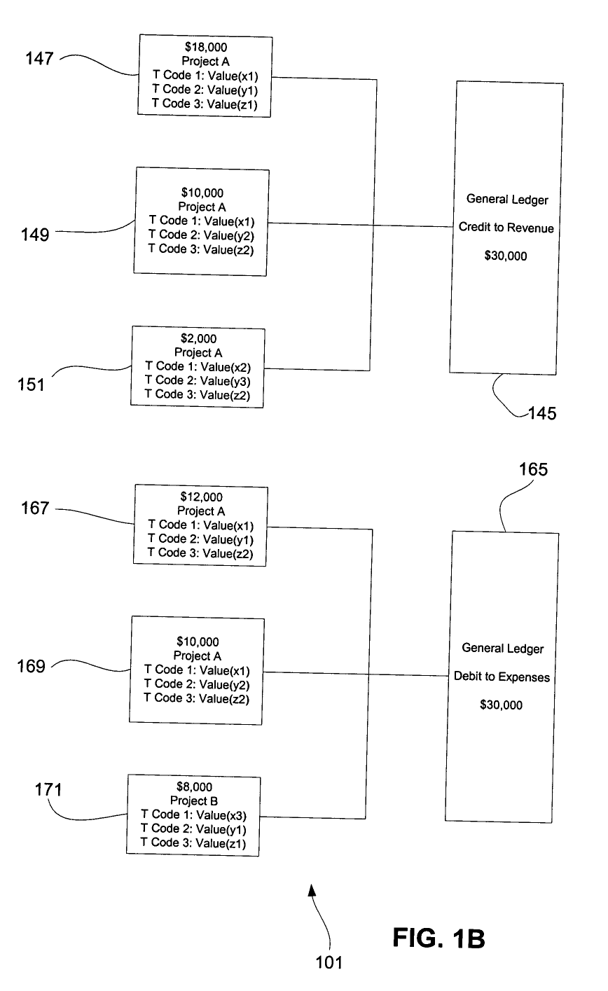

Turning now to FIG. 1A, an exemplary system 100 illustrating a series of typical and simplified transactions that must be tracked and analyzed by a not-for-profit organization is shown. The system 100 includes the not-for-profit organization 110, which receives donations 112 from a number of donors 114. Donors may be individuals or foundations, for example. And the donations may be in the form of cash, securities, grants, and endowments. Some of these donations have restrictions placed on their use, which may be permanent or temporary, and some are unrestricted. In this illustration, $30,000 in donations is received, of which $2,000 is permanently restricted, $10,000 is temporarily restricted, and $18,000 is unrestricted.

These donations are received by the not-for-profit 110, which then uses these funds for various purposes. Although not shown, the $2,000 in restricted funding is placed in a bank account and the interest derived therefrom is used by the not-for-profit in accordance with its charter. Of the remaining $28,000, for example, a first $10,000 is used for a specific humanitarian relief project, with $8500 of the $10,000 going toward general emergency relief efforts and $1500 going specifically for youth services associated with the humanitarian relief project. Another $6,000 is used for an elder care project 130 in which the not-for-profit is involved. Another $9,000 is used for a specific shelter project 140, with $4,000 of that amount devoted generally to the homeless shelter, $2,500 devoted to the soup kitchen run by the shelter, and $2,500 devoted to youth services of the shelter. Of the remaining $3,000 of the original $30,000 donation, $2,000 is used for the purchase of supplies and equipment from a wholesale distributor 150. These supplies include general office supplies 152 at a price of $500 and computer equipment 154 at a price of $1,500. The final $1,000 of the original $30,000 donation is used for administrative expenses and utility costs 160.

Obviously, this is a very simplified example of the types of transactions a not-for-profit organization 110 must track, monitor, and, at times, analyze and report on. Not-for-profit organizations 110 rely upon computer systems 125 that have accounting software installed therein that stores, tracks, analyzes, and generates reports about such transactions that are maintained in its database 135 of financial data.

FIG. 1B illustrates a balancing transaction 101 in a block diagram format. These transactions use and take advantage of project codes and transaction codes of the present invention to describe the purpose and use of the funds received and distributed. For example, the first half 145 of this transaction includes a credit to revenue on the general ledger of the accounting system in the amount of $30,000. Of this $30,000 donation, an $18,000 portion 147 is allocated to Project A and to transaction code 1 (T Code 1) at a value of X1, to transaction code 2 (T Code 2) at a value of Y1, and to transaction code 3 (T Code 3) at a value of Z1. By way of example, Project A may be equivalent to “Hurricane Hugo Relief Project;” transaction code 1 may be “Mission” with possible values (X1, X2, . . . , Xn) of “General Emergency Relief,” “Soup Kitchen,” “None,” and “Home Reconstruction,” among others; transaction code 2 may be “Spendable/Non-spendable” with possible values (Y1 or Y2) of “spendable” or “non-spendable” only; and transaction code 3 may be “Region” with possible values (Z1, Z2, . . . , Zn) of “North Charleston,” “Downtown Charleston,” and “Isle of Palms” among others. Of this $30,000, another $10,000 portion 149 is also allocated to Project A but to transaction code 1 (T Code 1) at a value of X1, to transaction code 2 (T Code 2) at a value of Y2, and to transaction code 3 (T Code 3) at a value of Z2. The final $2,000 portion 151 of the $30,000 is also allocated to Project A but to transaction code 1 (T Code 1) at a value of X2, to transaction code 2 (T Code 2) at a value of Y3, and to transaction code 3 (T Code 3) at a value of Z2. The second half 165 of this transaction includes a debit to expenses on the general ledger of the accounting system in the corresponding amount of $30,000. Of this $30,000 expense, a $12,000 portion 167 is allocated to Project A and to transaction code 1 (T Code 1) at a value of X1, to transaction code 2 (T Code 2) at a value of Y1, and to transaction code 3 (T Code 3) at a value of Z2. Of this $30,000 expense, another $10,000 portion 169 is allocated to Project A and to transaction code 1 (T Code 1) at a value of X1, to transaction code 2 (T Code 2) at a value of Y2, and to transaction code 3 (T Code 3) at a value of Z2. The final $8,000 portion 171 of the $30,000 expense is allocated to Project B and to transaction code 1 (T Code 1) at a value of X3, to transaction code 2 (T Code 2) at a value of Y1, and to transaction code 3 (T Code 3) at a value of Z1. As shown, the two $10,000 portions of these transactions 149, 169, respectively, balance against each other across project and transaction codes. The remaining portions of this balancing transaction 101 do not specifically balance across project or transaction codes.

It should be understood that the use of transaction codes (or “T codes”) enables the accounting system to track financial data from multiple dimensions. T codes are data elements that reside on or are associated directly with transactions within accounts. As has been stated previously, this approach avoids the need to use extra account segment values. T codes allow users to compare and analyze financial data from a number of perspectives, again, without additional segments. T codes also enable users to produce complex reports, such as OLAP reports. Another benefit of using T codes is that it enables users to produce financial statements with accounts and subordinate T-codes on the face of the financial statements. T codes also allow users to preserve the equity balance of each data element in order to display prior years' activity to users. For example, if an organization used T-code value #1 to track NIH Grants, then the organization could use the preservation of equity feature to determine remaining fund balance associated with a particular grant from year to year. Further, system users can configure T codes so that the system will impose balancing requirements on all transactions coded to a given transaction characteristic. That balancing requirement combined with the preservation of equity allows users to produce a balance sheet by each transaction code value. In addition, each T code is configurable to require a value on particular transaction types. For example, if a user requires T codes on income statement accounts, then all data entry staff are required to assign a value to any transaction coded to a particular income statement account. Another benefit of T codes is that they are not limited to a numeric value, such as a typical segment value, but rather T codes of the present invention may be numeric, or have a short or long character string descriptions. Finally, as will be discussed in greater detail hereinafter, users are able to enter transactions directly in the journal entry of the accounting system and distribute that total amount of the transaction to appropriate T-codes using the distribution grid feature discussed hereinafter. Further understanding of transaction codes and their value and benefit will be understood from the screen shots and flow charts discussed hereinafter.

### Environment

Before describing the specific components and methodologies of the present invention associated with FIGS. 1A and 1B in greater detail, it will be helpful to understand the operating environment, data, account, and record structures, and standard components of a preferred accounting software system used by the computer systems 125 and within which the present invention preferably operates. This will be done with reference to a plurality of exemplary screen shots showing a system user's perspective of the accounting software. Those skilled in the art will understand and appreciate the underlying functionality and programming necessary to generate and utilize such computer screens. It should be understood further that these screen shots are shown merely for illustrative and explanatory purposes and not for purposes of limiting the scope or applicability of the present invention. Those skilled in the art will understand and appreciate that the present invention has broad utility within many accounting systems regardless of the specific layout, look and feel, and interface used by the system to interact with system users.

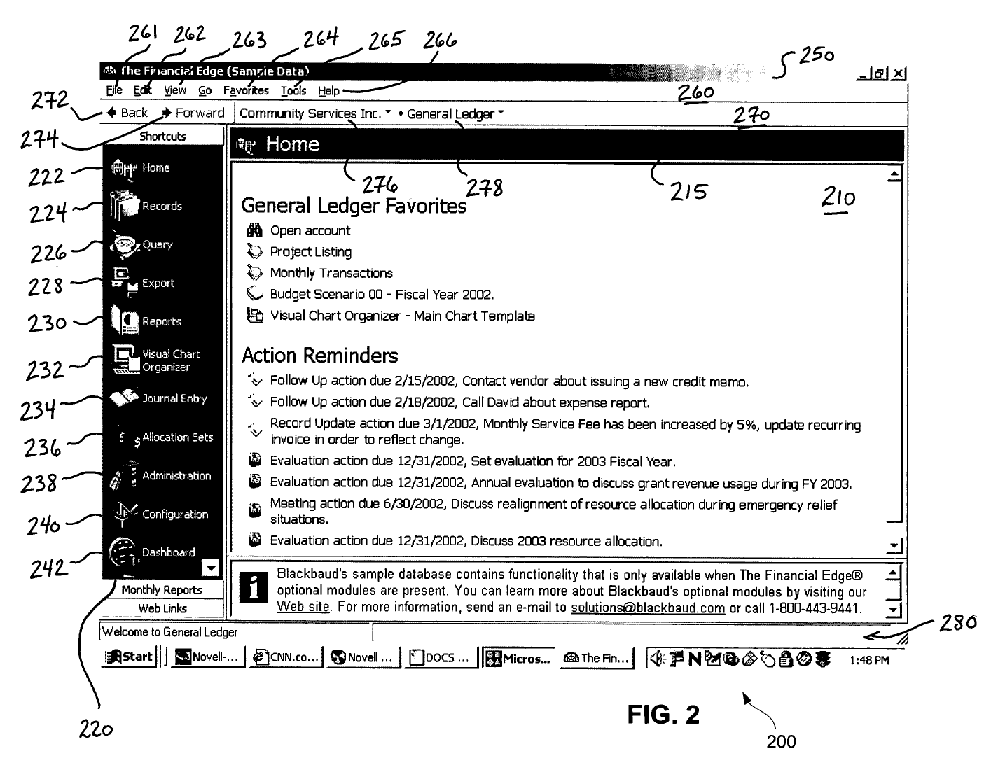

Turning now to FIG. 2, a screen shot of an exemplary user interface 200 (or “shell”) generated by a preferred accounting system of the present invention is illustrated. A primary purpose of the preferred embodiment of the present invention is to provide easy navigation. Thus, the user interface 200 has the look and feel of a conventional web browser, which makes maneuvering between programs, modules, and functions simple and intuitive. This user interface provides many benefits, including the ability to move back and forward with a click of a computer mouse and a centralized location for accessing the various subsystems and components of the system.

The user interface 200 includes a primary display area 210 and a navigation bar 220. The primary display area 210 further includes a title bar 215, which tells the user what subsystem or component is currently being accessed and displayed in the display area 210. Currently, the general ledger “home” page, which is customizable by the user, is displayed within display area 210. The navigation bar 220 includes logos and words, each of which are hyperlinked to different subsystems and components of the system. The user is able to “hide” the navigation bar 220 and move it to the top, bottom, left, or right side of the user interface 200. When any one of the links is activated in conventional manner, the start page for that subsystem or component is preferably displayed within the display area 210 (and in some cases as a separate window). As illustrated, the navigation bar 220 includes “short cut” links to home 222, record 224, query 226, export 228, reports 230, visual chart organizer 232, journal entry 234, allocation sets 236, administration, 238, configuration 240, and dashboard 242. Some of these subsystems and components, which are relevant to the present invention, will be described in greater detail hereinafter.

The user interface 200 also includes a title bar 250, a menu bar 260, a toolbar 270, and a status bar 280. The title bar 250 at the top of the shell usually displays the name of the program and includes standard Windows® buttons to minimize, maximize, and close the program. When in a specific record, the title bar 250 displays the “saved” name of the record. The menu bar 260 under the title bar 250 displays accessible menus containing commands for various functions. The menus typically include file 261, edit 262, view 263, favorites 264, tools 265, and help 266. The current screen display 210 includes go 267, as an additional menu bar option. Other menu bar options available on some screens (not shown) include account, project, batch, vendor, and asset menu options. The commands available within each menu depend on the area of the system currently being accessed.

The toolbar 270 appears under the menu bar 260 and provides “back” and “forward” buttons 272, 274, respectively, that enable the user to quickly move back and forth between screen and system modules. The toolbar 270 also preferably displays the name 276 of the organization for which the user works or is associated and the specific program 278 in which the user is working. The specific program 278 area includes a pull-down menu from which the user can select from general ledger, accounts payable, accounts receivable, fixed assets, and cash receipts. The present invention will be directed to functionality associated primarily with general ledger.

The status bar 280 appears across the bottom of a screen or record and acts as a guide within the system—displaying important messages or helpful information, as necessary.

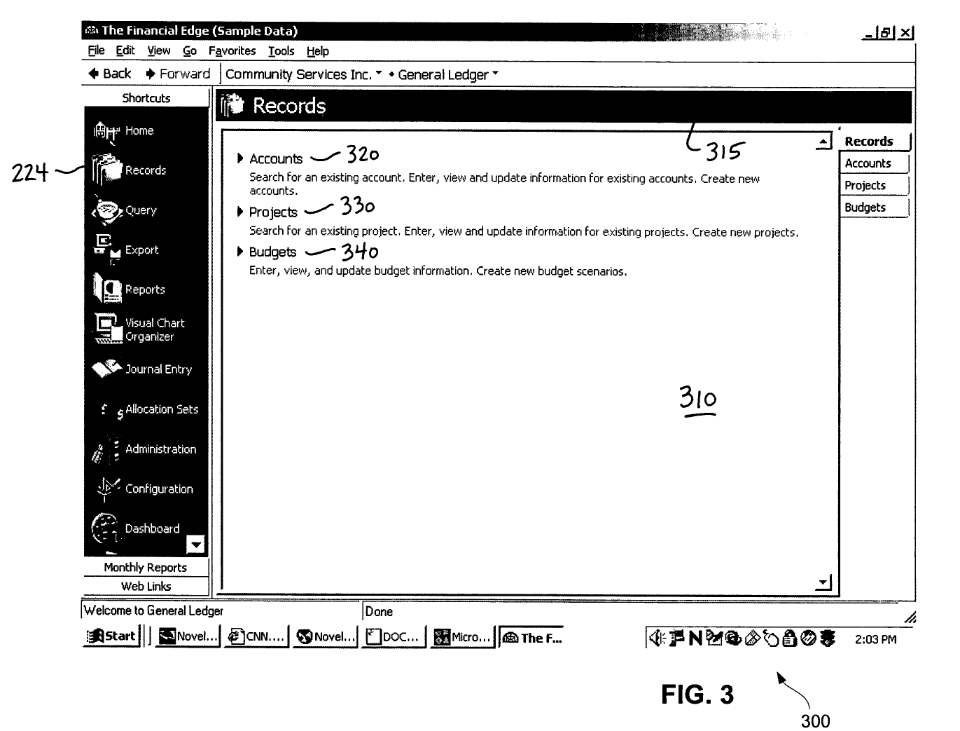

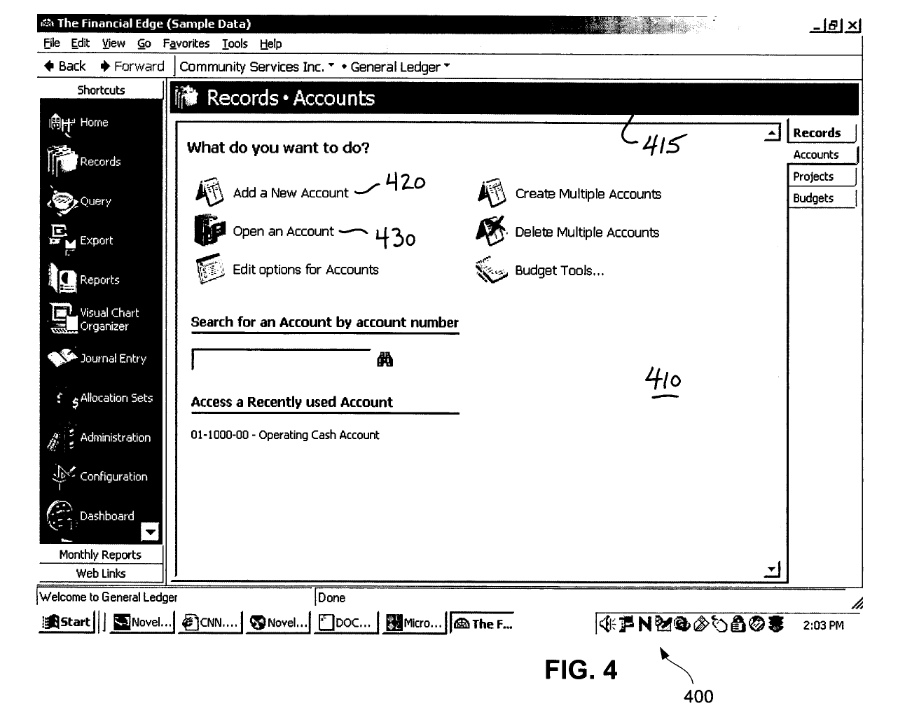

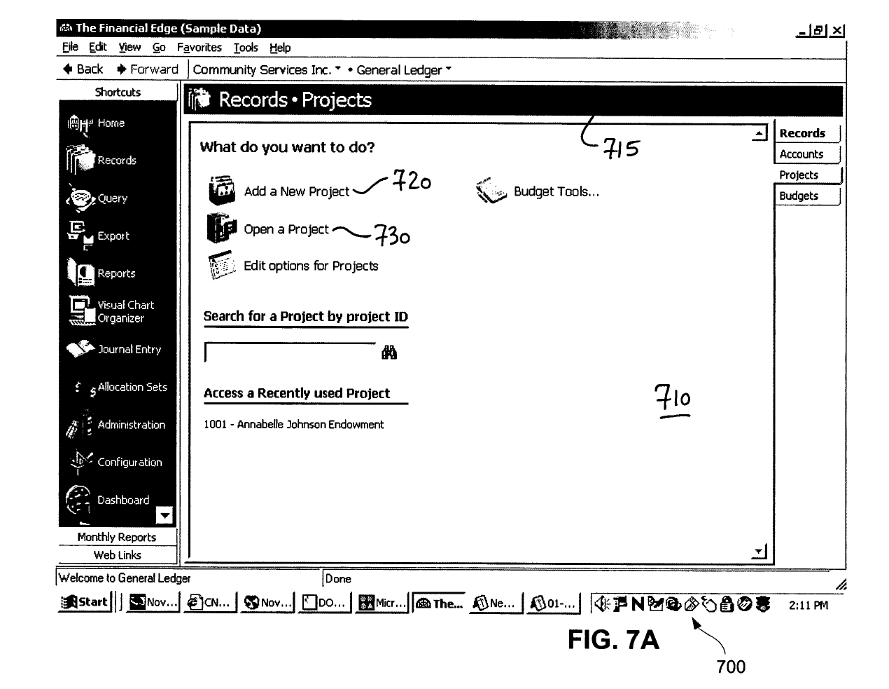

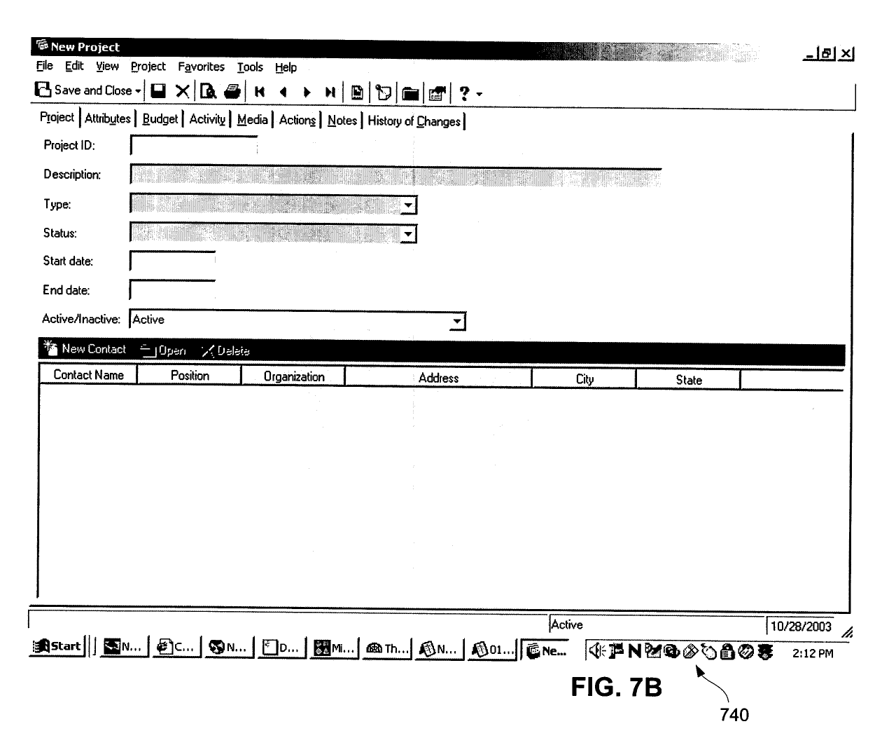

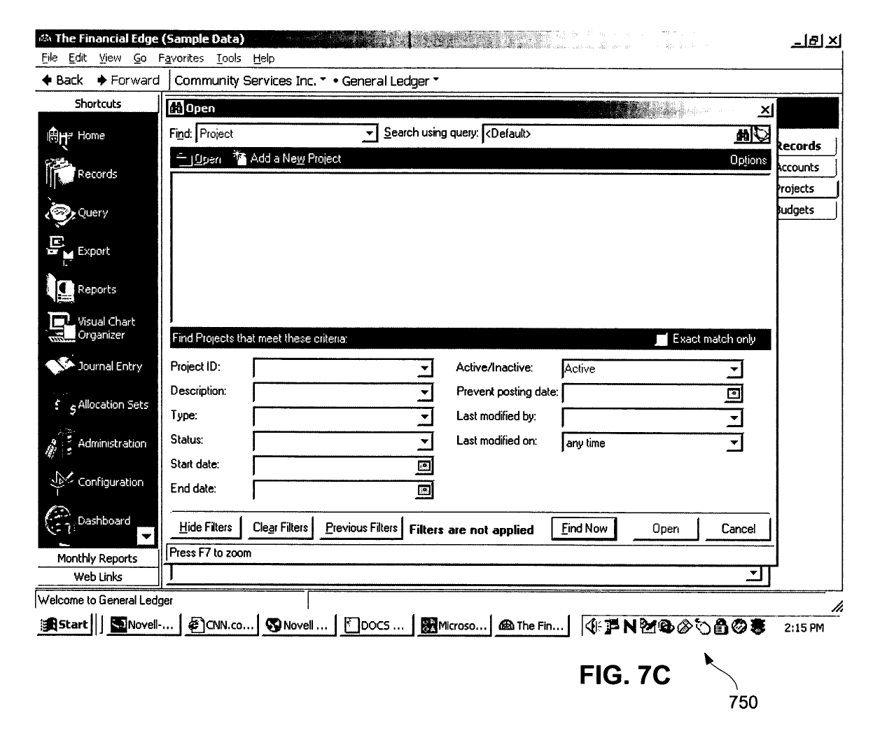

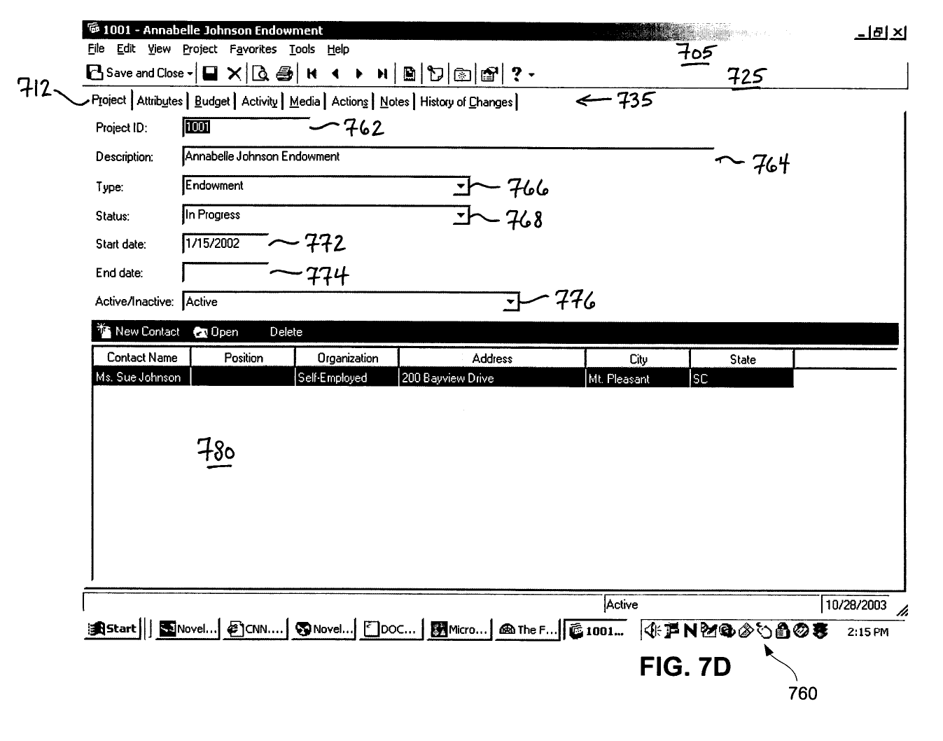

As shown in FIG. 3, when the records 224 hyperlink is activated, the records start page 300 is displayed in display area 310, as confirmed by the title displayed in the title bar 315. Preferably, users are able to access their account, project, and budget records from this records start page 300. Correspondingly, this page 300 contains links 320, 330, 340 to the accounts page (see FIG. 4), the projects page (see FIG. 7), and the budgets page (not illustrated), respectively.

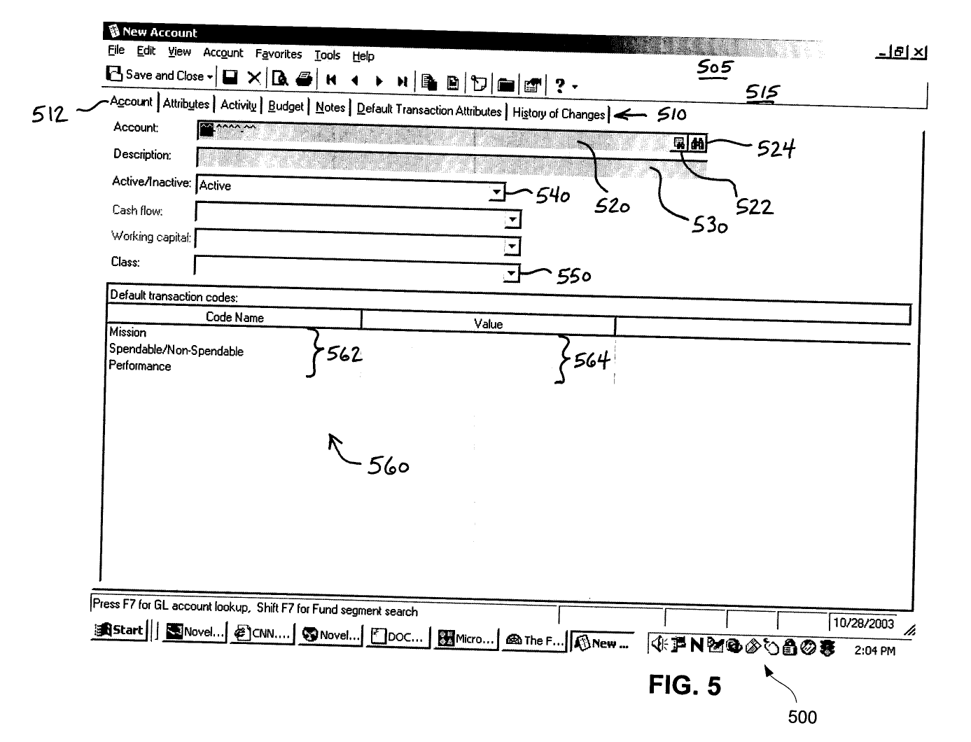

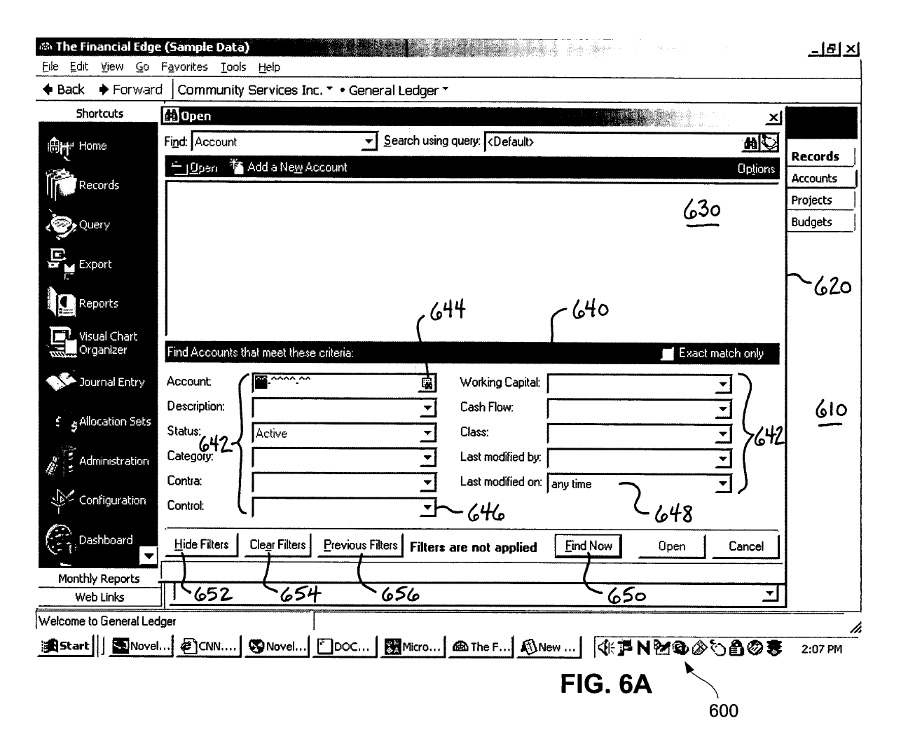

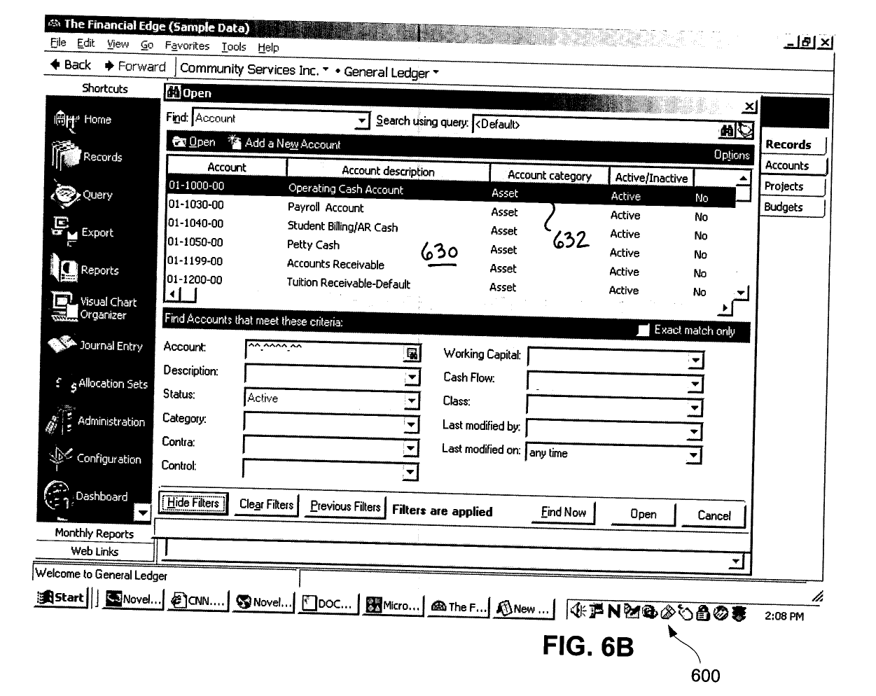

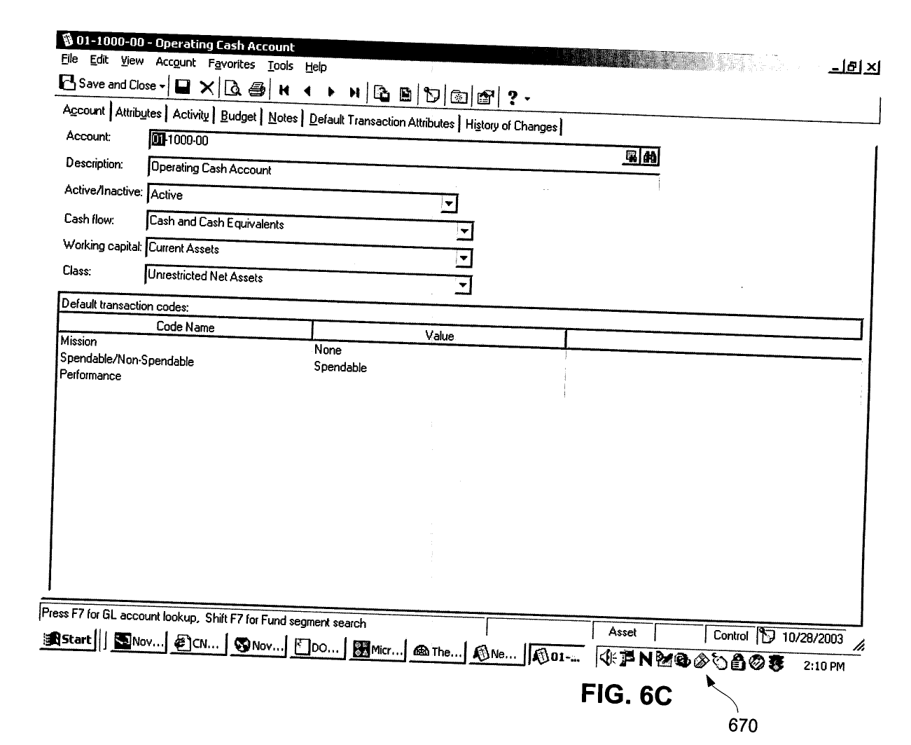

Turning now to FIG. 4, an account start page 400 is displayed in display area 410, with its title displayed in title bar 415. From this account start page 400, users access a “new account” page by activating link 420 (see FIG. 5) or access an “existing account” by activating link 430 (see FIG. 6).

With reference first to FIG. 5, the new account page or window 500 is preferably displayed as a separate window from the display area 410 of the previous account start page 400. The new account page 500 enables the user to create a new account, to define its characteristics, and to begin to associate data therewith. The new account page 500 includes a conventional menu bar 505 and tool bar 515. The new account page 500 also is divided into a number of “tabbed” sub-pages, as shown by the plurality of tabs 510 below the tool bar 515. These tabbed sub-pages preferably include a general account information page, an attributes page, an activity page, a budget page, a notes page, a default transaction attributes page, and history of changes page—some of which are described in greater detail hereinafter. Generally, these tabbed sub-pages provide data input fields and locations in which the user can define, characterize, and describe the account. These tabbed sub-pages also provide further information about the account that is generated and updated automatically by the system and viewable by the user. As shown, the new account page 500 defaults to the general account information sub-page, indicated by tab 512. This account information subpage includes a plurality of fields, including account number field 520 that enables the user to input an account number for the new account 520. The account number can be typed directly into field 520 or the user can select an available account number after accessing an account code segment look-up table (by activating button 522) or an account number look-up table (by activating button 524). This sub-page also includes a description field 530, into which the user can type in a preferred written description of the new account. The account information sub-page further includes an active/inactive status line 540 and a class description 550. As stated previously, available class descriptions for the new account include: (i) unrestricted, (ii) temporarily restricted, and (iii) permanently restricted.

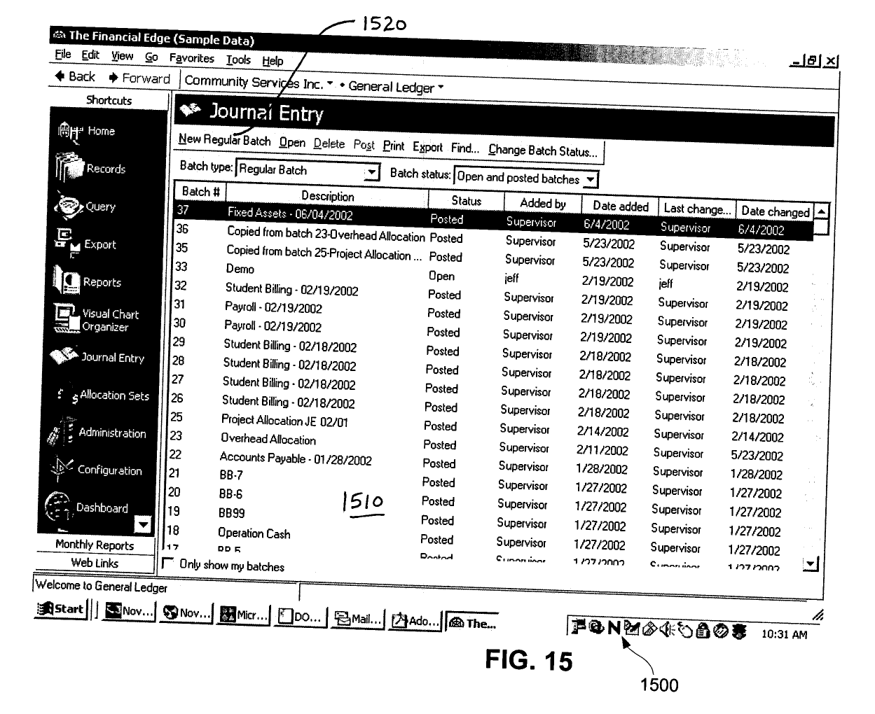

Still with reference to FIG. 5, the account information sub-page also includes a transaction code table 560. The transaction codes 562 shown in transaction code table 560 enable the user to define what “default” transaction codes will be used for any transactions associated with this particular account. In fields 564, the user is also able to specify a “default” value, if desired, for each transaction tracking code 562. As will be explained hereinafter in association with FIGS. 15A-15C, the user is able to define and configure each transaction code and the list of permissible values each transaction code may have. If the user specifies default transaction codes and associated default values with a particular account, such default values will automatically be used whenever this account is later referenced. Nevertheless, the user always has the option of over-riding such defaults values when inputting a specific transaction, as necessary. In the particular example, only three transaction codes are illustrated: “mission,” spendable/non-spendable,” and “performance.” Although not shown here, current permissible values for each transaction code are accessible using a pull-down menu associated with each “value” field.

By activating link 430 in FIG. 4, the user is presented with a search screen 600, as shown in FIG. 6A, from which the user initiates a search to find an existing account for viewing and/or further editing. The search screen 600 may be displayed within display area 610 or as a separate window 620 (as shown), which, in this case, allows a larger screen area to be used than is available in the display area 610. The window 620 includes two primary sections: a search results display area 630 and a filter area 640. Before any searches have been run, the search results display area 630 is empty, as shown. The filter area 640 includes a plurality of fields 642 in which the user can specify particular search parameters. Each of the fields includes a look-up table 644 or a pull-down menu option 646, and a text entry area 648 in which a search term(s) is typed. Once at least one search parameter is input by the user, an account search is initiated by activating or selecting the “find now” button 650. Depending upon the search parameters, no accounts may be found or one or more accounts may be found and listed in display area 630, as shown in FIG. 6B. To increase the viewable size of the display area 630, the user selects button 652 to “hide filters.” The user is able to clear or reset all previous search parameter fields 642 by selecting button 654 to “clear filters.” The user is also able to display search results from a previous search by selecting the “previous filters” button 656. Turning briefly to FIG. 6B, by selecting or “double clicking” on one of the accounts 632 found during a search and displayed in area 630, an account detail page is then displayed. The account detail page 670, associated with account 632 from FIG. 6B, is illustrated in FIG. 6C. The account detail page 670 is essentially the same as the new account page 500 from FIG. 5 except all of the data fields and account details are populated with information already associated with or input into the account record.

By activating the “projects” link 330 from FIG. 3, the user is presented with a project start page 700, as shown in FIG. 7A. The project start page 700 is displayed in display area 710, as indicated by title bar 715. From this project start page 700, users access a “new project” page by activating link 720 or access an “existing project” page by activating link 730. The new project page 740, illustrated in FIG. 7B, is set up in a format quite similar to the new account page 500 from FIG. 5A but with data fields that are relevant to projects (e.g., Project ID, project type, project status, start and end dates, etc.) rather than to accounts. Project types include grants, endowments, member projects, service projects, and similar types that are user-definable. Project status include “in progress,” “pending application,” “closed,” and the like, again, which are user-definable. FIG. 7C illustrates a find projects search screen 750, which is accessed by activating link 730 on FIG. 7A. The project search screen 750 is very similar in format and function to the account search screen 600 from FIG. 6A. An actual project detail page 760 is illustrated in FIG. 7D. Similar to an account detail page, the project detail page 760 includes a conventional menu bar 705 and tool bar 725. The project detail page 760 is also divided into a number of “tabbed” sub-pages, as shown by the plurality of tabs 735 below the tool bar 725. These tabbed sub-pages preferably include a general project information page, an attributes page, an activity page, a budget page, a media page, an actions page, a notes page, and history of changes page. These sub-pages provide data input fields and locations in which the user can define, characterize, and describe the project. These sub-pages also provide further information about the project that is generated and updated automatically by the system and viewable by the user. As shown, the project detail page 760 defaults to the general project information sub-page, indicated by tab 712. This project information sub-page includes a plurality of fields, including project ID 762, project description 764, project type 755, project status 768, start date 772, end date 774, active/inactive status bar 776, and a project contact list 780.

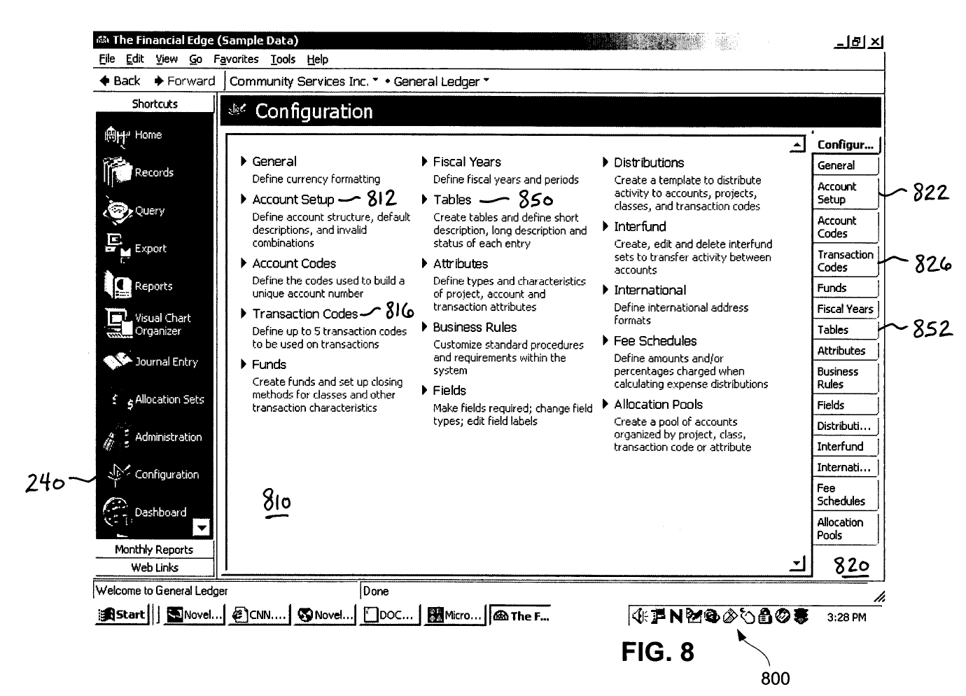

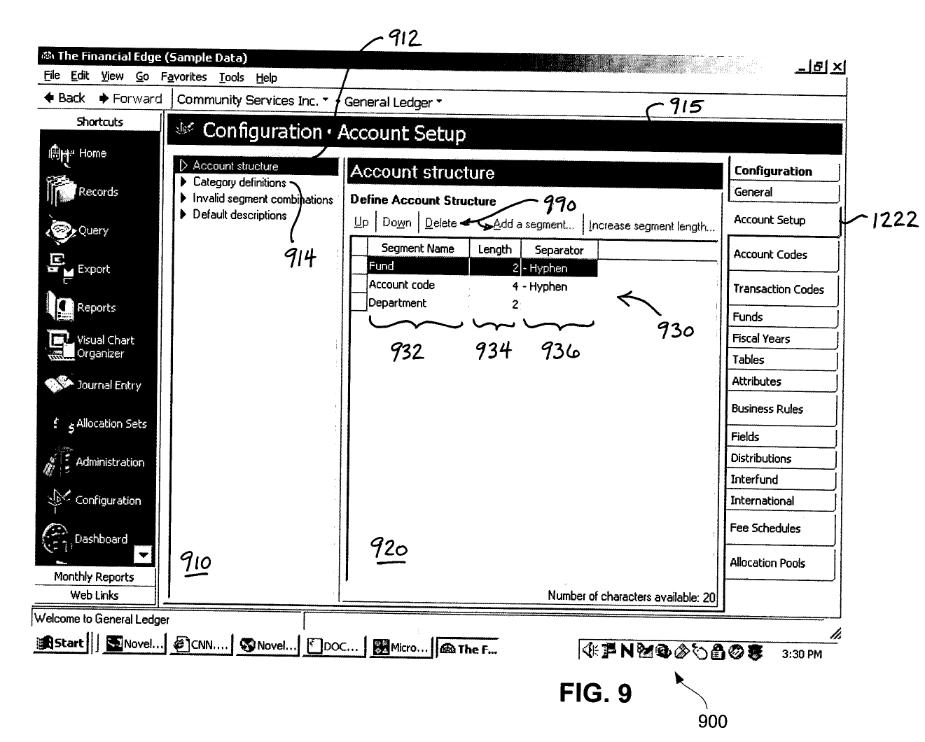

A system configuration main page 800 is illustrated in FIG. 8. This page is accessed by activating the configuration link 240 from FIG. 2. The system configuration main page 800 includes a number of links in display area 810, with corresponding tabs accessible in tab area 820. By selecting or activating the account setup link 812 or account setup tab 822, the user is taken to an account setup main page 900, as shown in FIG. 9.

The account setup main page 900 of FIG. 9 includes a title bar 915, a primary topic area 910, and a specific configuration input area 920. The tab area 820 from FIG. 8 is still viewable and accessible to the user on the right side of the screen. As shown, the user is permitted to define the account structure to be used by the accounting system by selecting the account structure link 912 in area 910, which then displays a table of options 930 for the user in configuration input area 920. Specifically, for account structure, the user specifies each account segment 932 to be used to define accounts in the system, the length 934 of each segment, meaning the number of alphanumeric characters that segment includes, and what type of separator 936 (if any) will follow each segment. As has been stated previously, the user is able to arrange the order of the segments, determine how many segments will be used, determine which segments will be used, and otherwise customize accounts numbers used by the accounting system as desired by the organization using this system using controls 990. The account structure must include at least one segment, which is preferably the account code. The “fund” account segment will also be used in most embodiments. Additional account segments, such as department, location, and other user-definable segments, are also available, but, as has been discussed previously, it is preferable that users define and make use of transaction codes rather than create addition segments.

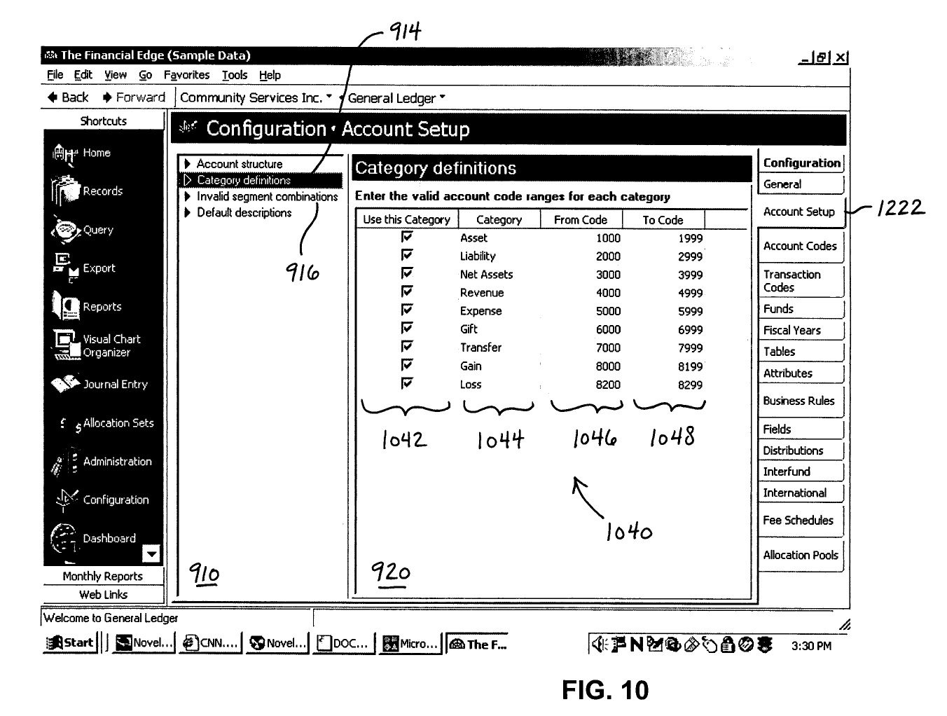

By activating the category definitions link 914 in area 910, an account category definition table 1040 is displayed in area 920, as shown in FIG. 10. The account category definition table 1040 preferably includes four columns of information. In column 1044, the nine standard account category types used by not-for-profit organizations are listed. These standard account categories include asset, liability, net assets, revenue, expense, gift, transfer, gain, and loss. The user is able to specify, by selecting or deselecting any of the check boxes in column 1042, which of the standard account categories will be used in the accounting system. In the preferred embodiment, assets, liabilities, net assets, revenue, expense, and transfer are required account categories—the others are optional and may be included or excluded using the check boxes in column 1042. Columns 1046 and 1048 are used to define the range of account codes associated with each account category. As shown, the current account codes use four digits—this corresponding to the length 934 of the account code segment from FIG. 9. Thus, the number of available accounts codes usable by the system hinges on the user's selection of the account code length from FIG. 9. The system will automatically input preferred ranges for each account category; however, the user is free to modify these ranges as desired.

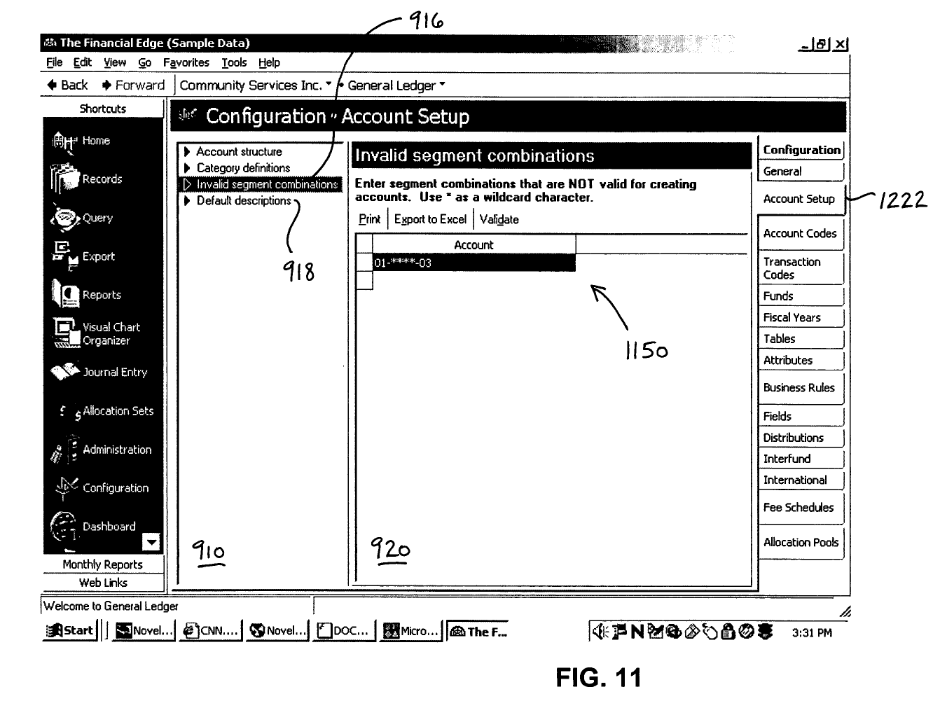

By activating the invalid segment combination link 916 in area 910, an invalid segment combination table 1150 is displayed in area 920, as shown in FIG. 11. The invalid segment combination table 1150 preferably includes one or more fields into which the user specifies what segment combinations are not permissible by the system. For example, as shown in the one entry of FIG. 11, fund 01 cannot be associated with department 03 regardless of the type of account and regardless of the specific account number used (as indicated by the **** wildcard characters). As should be readily apparent, there are an infinite number of specific invalid segment combinations that can be defined by the user—as desired or needed by the particular organization using the accounting system.

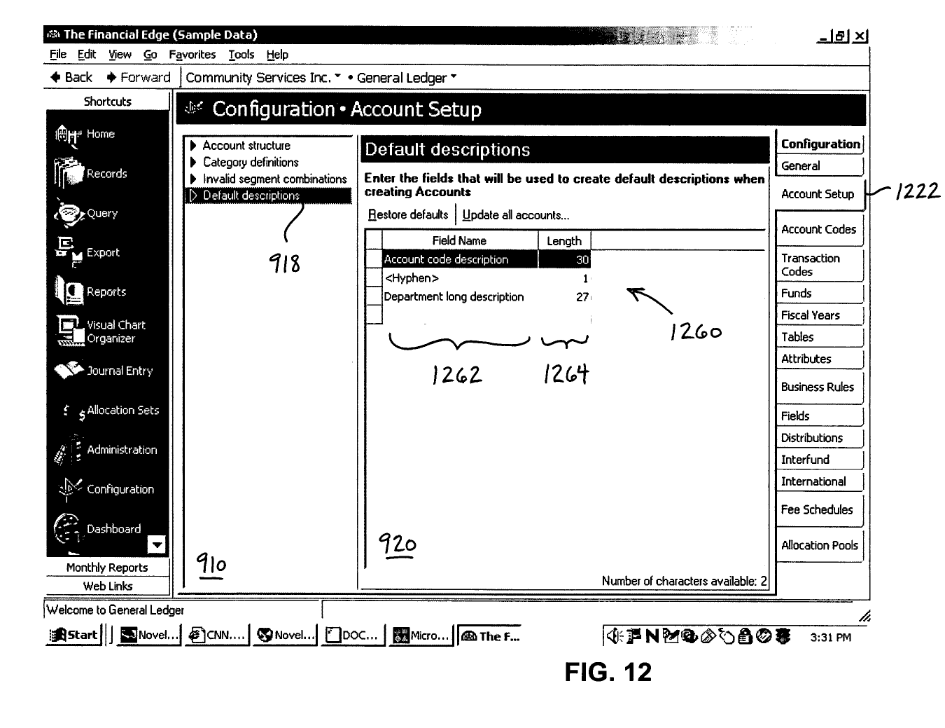

By activating the default descriptions link 918 in area 910, a default account descriptions table 1260 is displayed in area 920, as shown in FIG. 12. The default account descriptions table 1260 preferably includes columns of information that enable the user (i) to specify fields 1262 that will be used to create default descriptions for any account created by the user or created automatically by the system (when necessary and when permitted by the user in the system configurations) and the length 1264 of each such field.

### Transaction Code Screen Shots

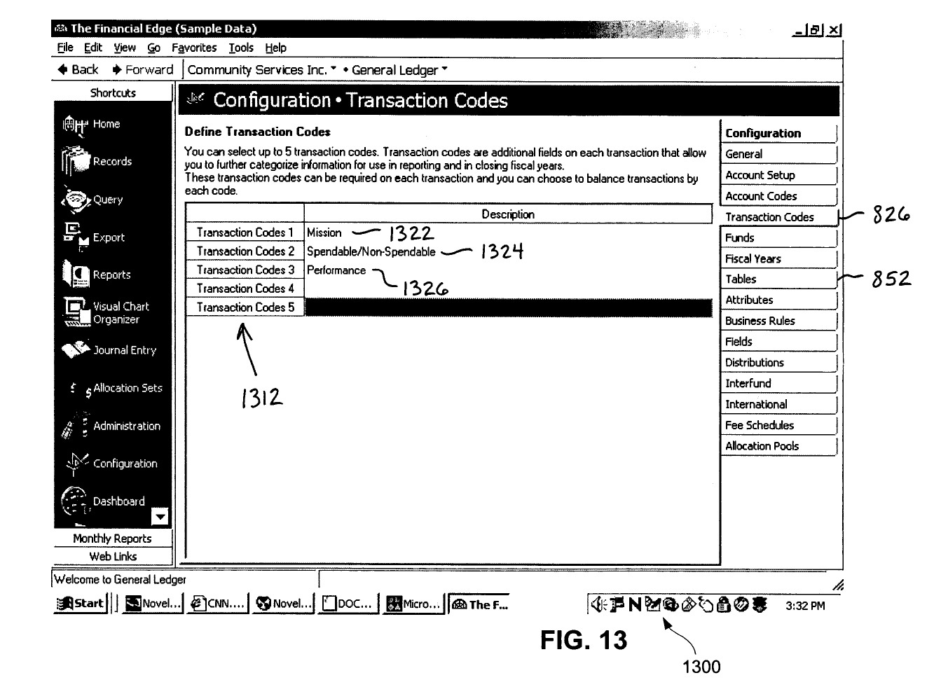

Turning back briefly to FIG. 8, by activating the transaction code link 816 or the transaction code tab 826, the user is taken to a transaction code setup page 1300, as shown in FIG. 13. The transaction code setup page 1300 includes a transaction code table 1310 that allows the user to define the plurality of transaction codes. In the preferred embodiment, the system allows up to five transaction codes to be defined, as shown in column 1312; however, the number and naming of such transaction codes is arbitrary. As shown, the user has already defined three of the five transactions codes: Mission 1322, Spendable/Non-Spendable 1324, and Performance 1326. With quick reference back to FIG. 5, the reader will recall that these three transaction codes were previously displayed as the three available transaction codes for the displayed account 500. It should be understood that any modification or additions to the transaction codes 1312 on the transaction code setup page 1310 will be reflected throughout the system, such as for account 500 in FIG. 5.

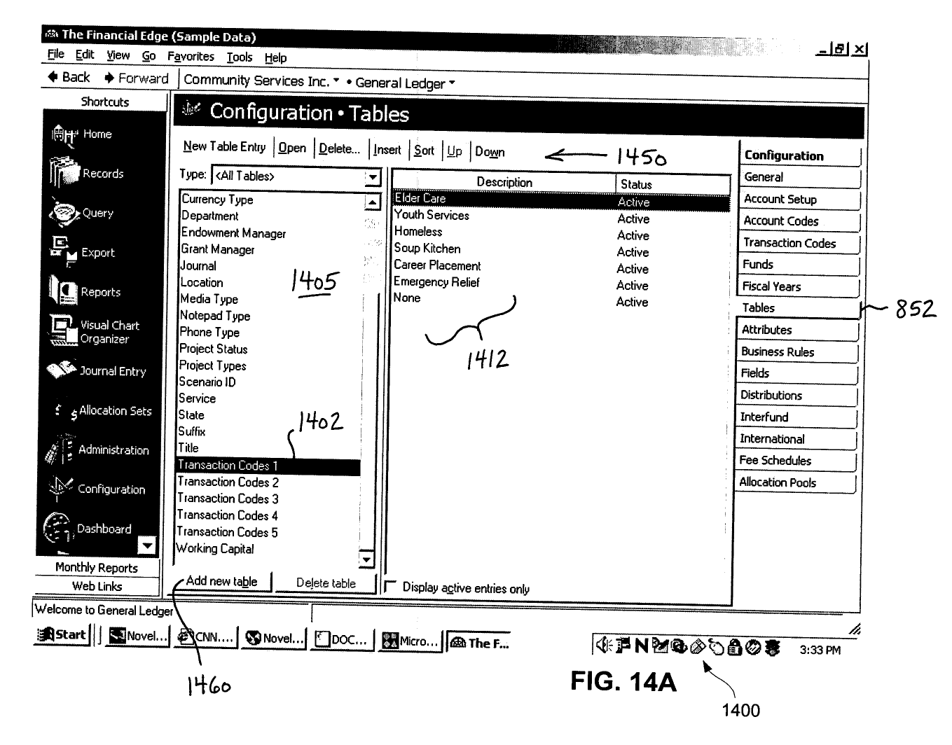

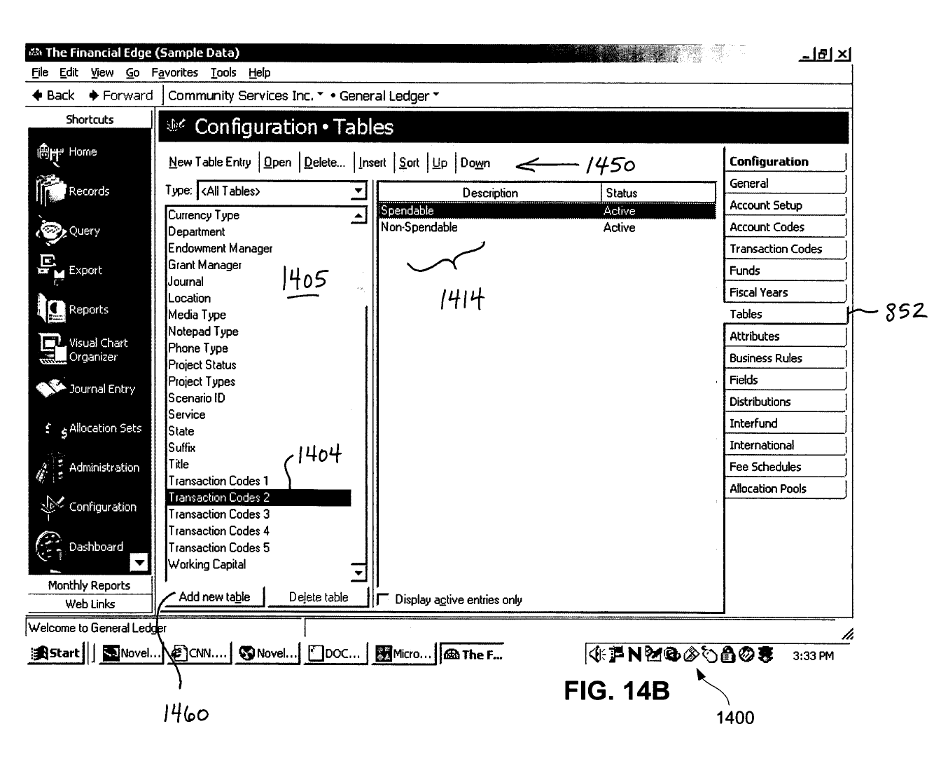

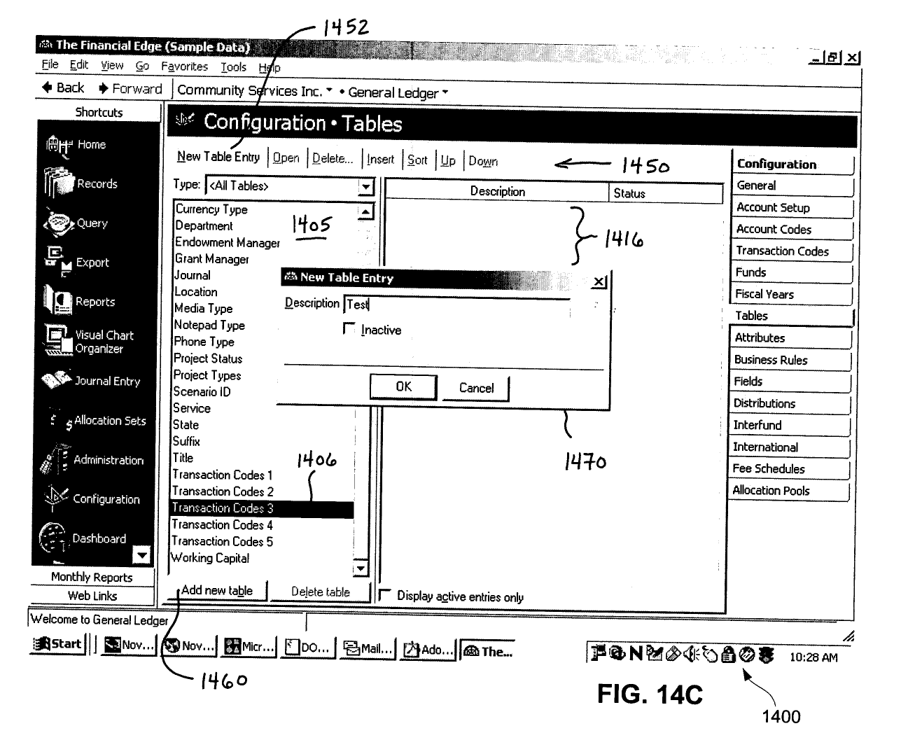

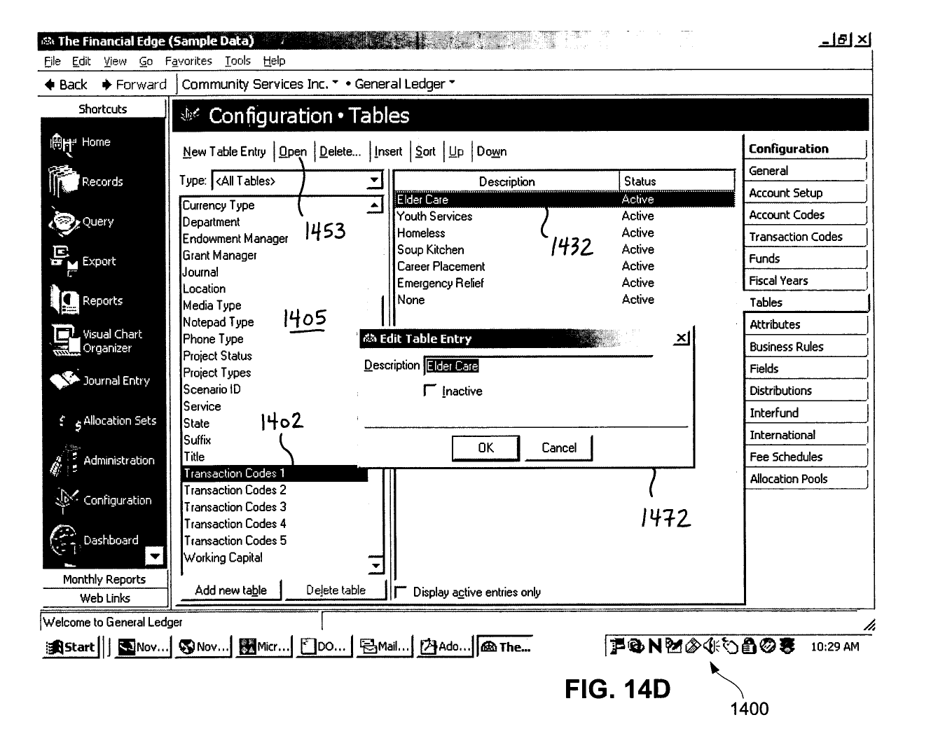

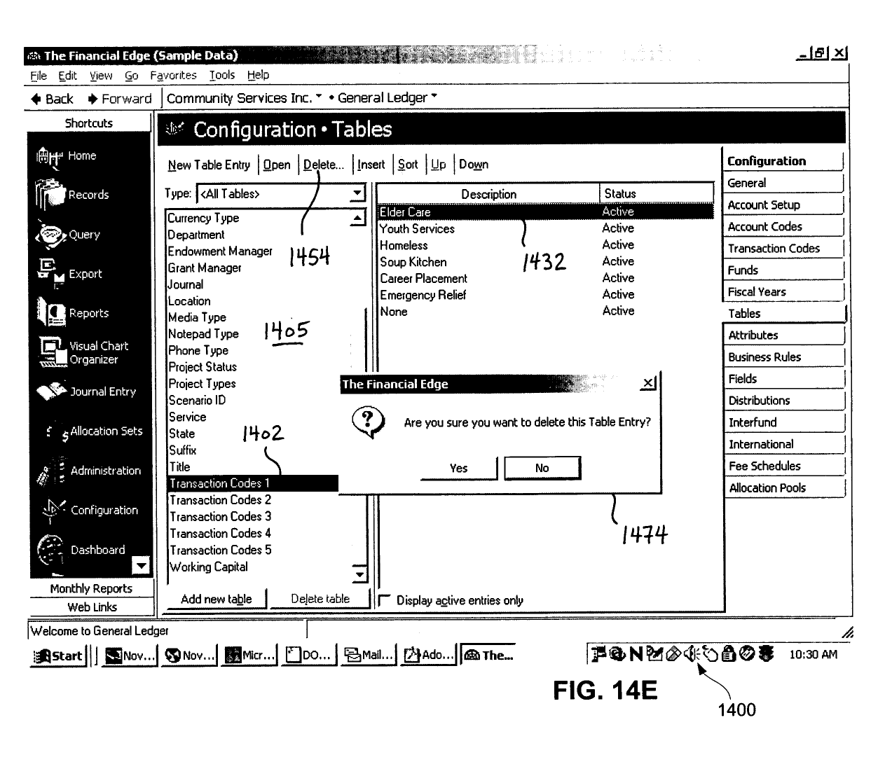

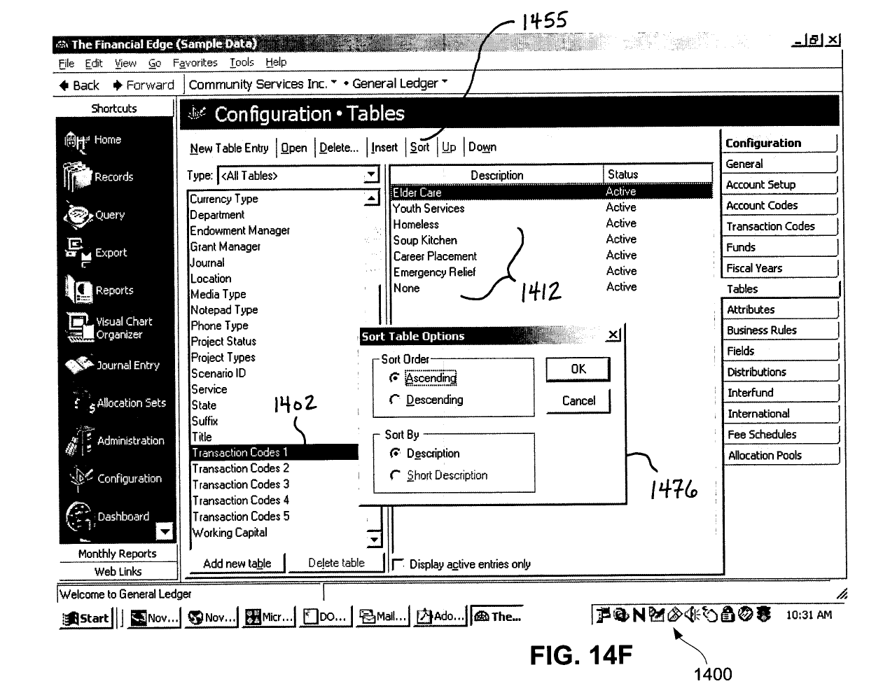

Once transaction codes are defined or created in table 1310, allowable or permissible values for each such transaction code are defined in configuration table 1400, as shown in FIGS. 14A through 14F. Configuration table 1400 is accessed by activating the table link 850 (as shown back in FIG. 8) or the table tab 852, as shown in FIG. 8 and in FIGS. 14A through 14F. FIG. 14A illustrates the values 1412 that have been defined for “transaction code 1” (i.e. Mission) 1402. FIG. 14B illustrates the values 1414 that have been defined for “transaction code 2” (i.e., Spendable/Non-spendable) 1404. Links 1450 enable the user to create a new transaction code value, and to delete, edit, insert, and sort the values currently listed in the table 1400. By activating the “Add New Table” button 1460, the user is able to define a new table in window 1405.

FIG. 14C illustrates “transaction code 3” (i.e., Performance) 1406, which has no current values defined. By activating the “New Table Entry” link 1452, the user is able to create or define a new value for the highlighted table, in this case “transaction code 3.” An input window 1470 opens so that the user can define the new value.

FIG. 14D illustrates use of the “Open” link 1453, which, when activated, opens an edit window 1472 for the highlighted value for the highlighted table, in this case, value “Elder Care” 1432 of “Transaction Code 1” 1402. FIG. 14E illustrates use of the “Delete” link 1454, which, when activated, opens a delete confirmation window 1474 for the highlighted value for the highlighted table, in this case, value “Elder Care” 1432 of “Transaction Code 1” 1402. FIG. 14F illustrates use of the “Sort” link 1455, which, when activated, opens a sort table option window 1476, which enables the user to sort the values 1412 for the highlighted table, in this case “Transaction Code 1” 1402. The sort window 1476 enables the user to sort such values in ascending or descending order based on description or short description.

### Use of Transaction Codes in Journal Entry

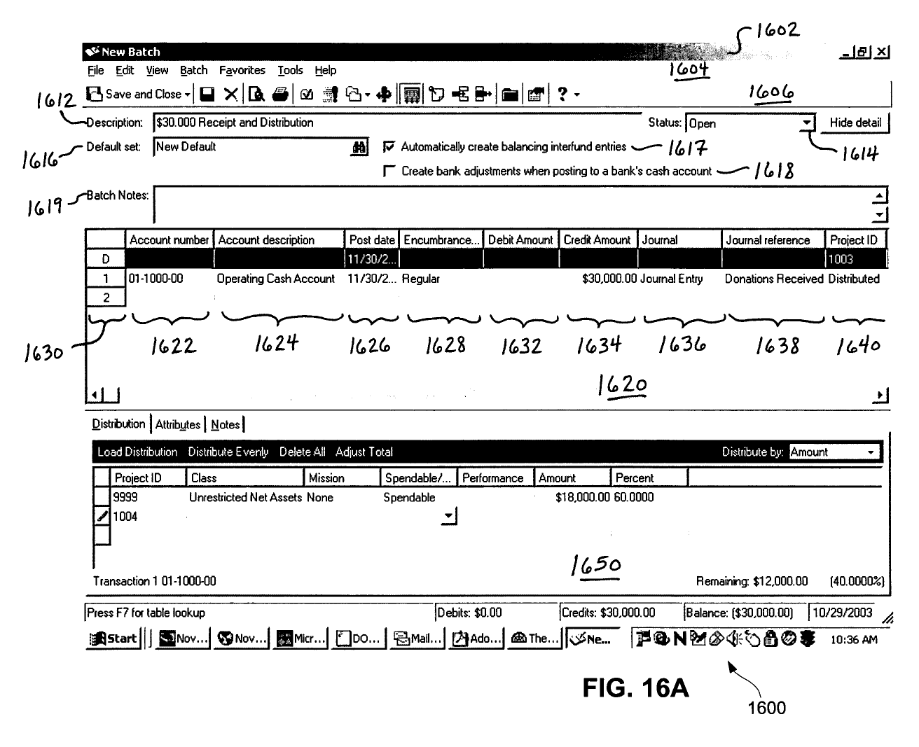

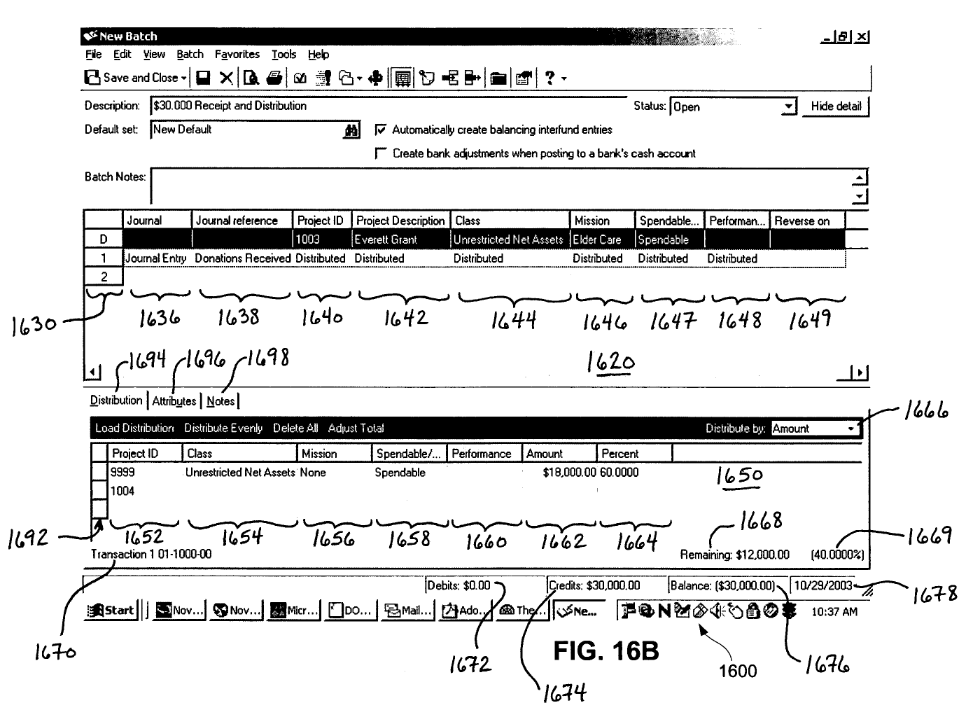

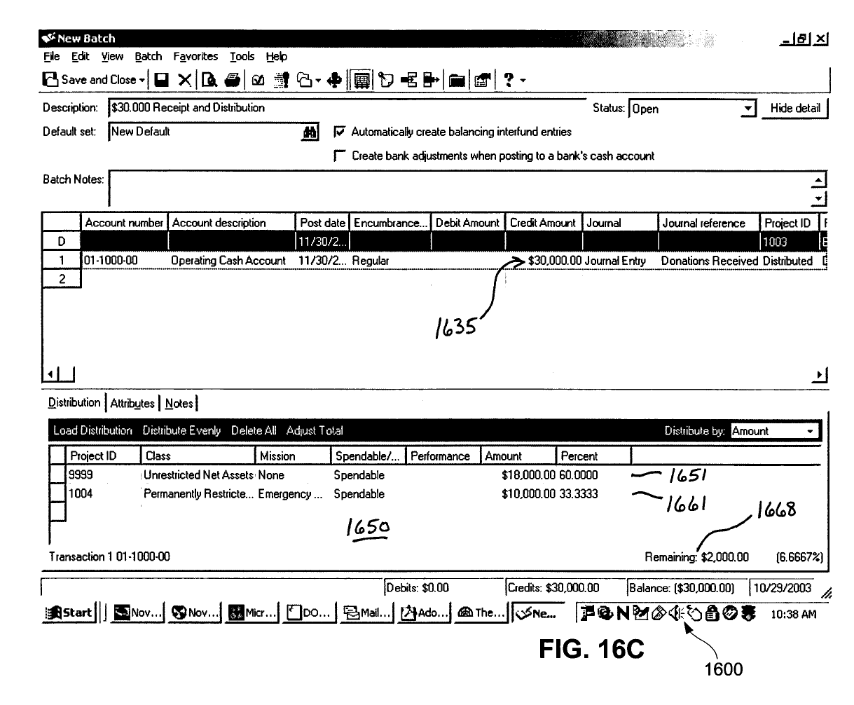

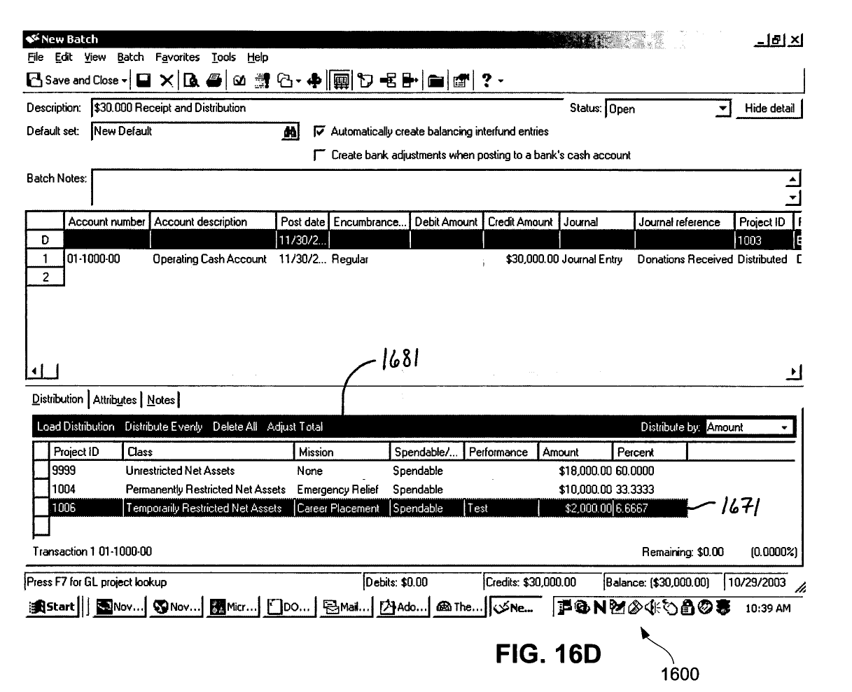

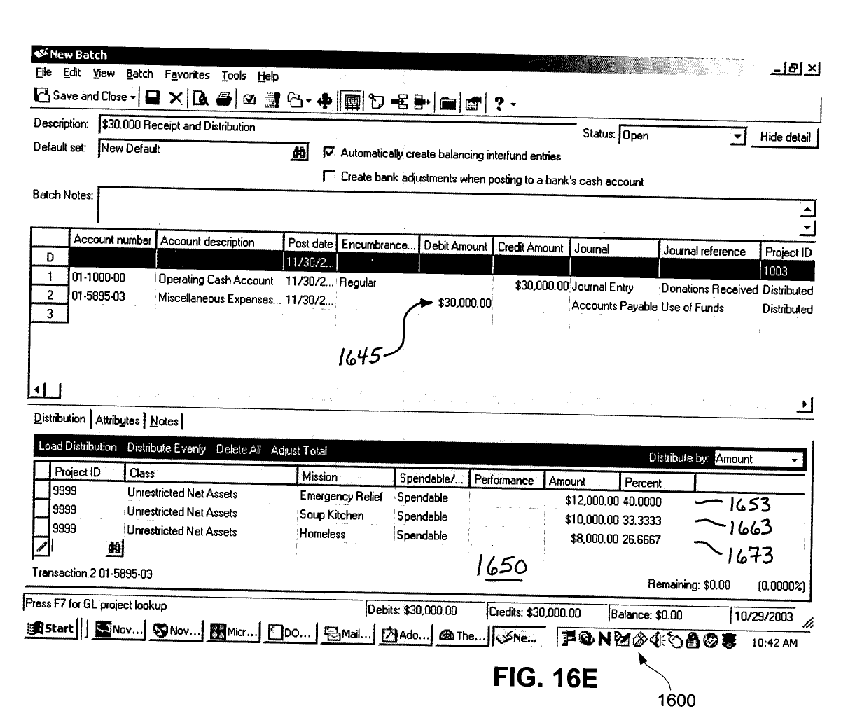

A conventional journal entry page 1500 is illustrated in FIG. 15. This page 1500 is accessed by activating the journal entry link 234 from FIG. 2. Table 1510 illustrates transaction batches that have already been processed by the system. To create a new batch, the user activates the New Regular Batch link 1520, which opens Create New Batch window 1600, as shown in FIGS. 16A through 16E.

Turning now to FIGS. 16A and 16B, the top section of the Create New Batch window 1600 includes standard title bar 1602, menu bar 1604, and toolbar 1606. The top section of window 1600 also includes a description field 1612, a status field 1614, and a default set entry field 1616, which enables the user to define a default transaction for this batch. The window 1600 also includes check boxes for automatically creating balancing interfund entries 1617 and for creating bank adjustments when posting to a bank's cash account 1618. The window also includes a notes field 1619.

The middle section of the window 1600 is a transaction entry table 1620. The rows 1630 of table 1620 show the default transaction values in row “D” and the data entered for transaction 1, 2, 3 and so on. Starting in FIG. 16A and continuing across in FIG. 16B, the columns of table 1620 include account number 1622, account description 1624, posting date 1626, encumbrance 1628, debit amount 1632, credit amount 1634, journal 1636, journal reference 1638, project ID 1640, project description 1642, class 1644, transaction code 1 (mission) 1646, transaction code 2 (spendable/non-spendable) 1647, transaction code 3 (performance) 1648, and “reversed on” date 1649. No columns are shown for transaction code 4 or 5 because these are not currently defined in the system.

The lower section of the window 1600 is a distribution table 1650, as shown by tab 1694. The attributes table accessed by tab 1696 and the notes table accessed by tab 1698 are beyond the scope of the present invention. Distribution table 1650 includes columns for project ID 1652, class 1654, transaction code 1 (mission) 1656, transaction code 2 (spendable/non-spendable) 1658, transaction code 3 (performance) 1660, amount 1662, and percentage 1664. No columns are shown for transaction code 4 or 5 because these are not currently defined in the system. Distribution table 1650 enables the user to input data based on amount or percentages by selecting option 1666.

When a transaction is entered into transaction entry table 1620, the user first specifies an account number in column 1622. Any default and associated values related to this account are “pre-populated” into columns 1624 through 1649. These values may be changed by the user at any time, as long as such changes do not violate any predefined rules. The user then enters either a debit or a credit amount into columns 1632,1634 respectively. If the entire amount of the debit or the credit can be allocated to a single project, and to a specific value for each of transactions codes 1, 2 and 3, then there is no need to use the distribution table 1650, which, in such a situation, merely replicates the same values in columns 1652 through 1660 as are in columns 1640, and 1644 through 1648. Further, the total amount of debits entered into the transaction entry table are shown at 1672, total amounts of credits are shown at 1674, current balance is shown at 1676, and the current entry date is shown at 1678.

If the amount of the debit or the credit needs to be distributed between projects, or across any transaction code value, then the user is able to distribute the transaction across any combination of project and transaction codes using distribution table 1650. Each distribution portion is given its own column 1692. The associated transaction number and account number is shown at 1670. As amounts or percentages are entered into columns 1662 or 1664, remaining amounts and percentages are shown at 1668 and 1669, respectively.

As shown in FIG. 16C, the $30,000 transaction 1635 is in the process of being distributed. In distribution table 1650, an $18,000 portion 1651 of the $30,000 transaction has been associated with project 9999, has been given a class of unrestricted net assets, has been assigned a value of “none” for Mission (T Code 1), has been assigned a value of “spendable” for Spendable/Non-Spendable (T Code 2), and no value for Performance (T Code 3). Its corresponding percentage is shown. A $10,000 portion 1661 of the $30,000 transaction has been associated with project 1004, has been given a class of permanently restricted net assets, has been assigned a value of “Emergency Relief” for Mission (T Code 1), has been assigned a value of “spendable” for Spendable/Non-Spendable (T Code 2), and no value for Performance (T Code 3). The remaining amount that needs to be distributed is shown at 1668. FIG. 16D illustrates this remaining $2,000 distribution 1671. This $2,000 portion 1671 of the $30,000 transaction has been associated with project 1006, has been given a class of temporarily restricted net assets, has been assigned a value of “Career Placement” for Mission (T Code 1), has been assigned a value of “spendable” for Spendable/Non-Spendable (T Code 2), and has been assigned a value of “test” for Performance (T Code 3). Options 1681 enable the user to quickly modify the distributions previously entered by (i) loading pre-saved distributions, (ii) redistributing amounts evenly, (iii) deleting all, or (iv) adjusting the total to match the amounts entered, which causes the amount of the transaction to change in transaction entry table 1620.

FIG. 16E illustrates a balancing debit transaction 1645 also in the amount of $30,000. This amount has been distributed uniquely in distribution table 1650. Specifically, a $12,000 portion 1653 of the $30,000 debit transaction has been associated with project 9999, has been given a class of unrestricted net assets, has been assigned a value of “Emergency Relief” for Mission (T Code 1), has been assigned a value of “spendable” for Spendable/Non-Spendable (T Code 2), and no value for Performance (T Code 3). Its corresponding percentage is shown. A $10,000 portion 1663 of the $30,000 debit transaction has been associated with project 9999, has been given a class of unrestricted net assets, has been assigned a value of “Soup Kitchen” for Mission (T Code 1), has been assigned a value of “spendable” for Spendable/Non-Spendable (T Code 2), and no value for Performance (T Code 3). The remaining $2,000 portion 1673 of the $30,000 debit transaction has been associated with project 9999, has been given a class of unrestricted net assets, has been assigned a value of “Homeless” for Mission (T Code 1), has been assigned a value of “spendable” for Spendable/Non-Spendable (T Code 2), and has been assigned a value of “test” for Performance (T Code 3).

Although only shown in general ledger, it should be understood that transaction codes are usable for tracking transactions entered or posted through accounts payable, accounts receivable, cash receipts, payroll, fixed assets, student billing, fundraising, and other accounting system or module in which transactions are input or entered.

### Methods of the Present Invention

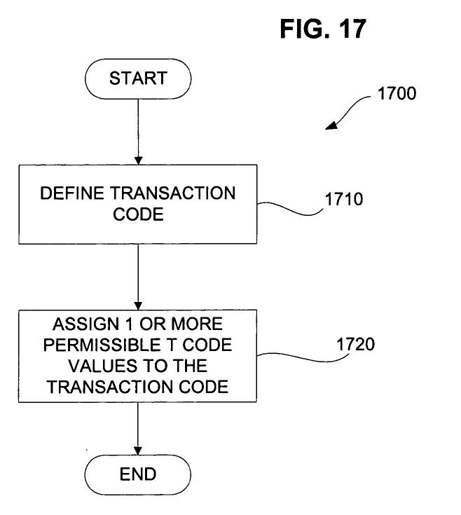

Turning now to FIG. 17, a method 1700 of setting up transaction codes for use with the accounting system is illustrated. The first step is to define (step 1710) the transaction codes that are usable by the system. This step corresponds to the screen shot from FIG. 13. The transaction codes are, preferably, user definable; however, in some circumstance, it may be desirable to use default transaction codes that are most-commonly used. Although not shown, another embodiment enables the user to select a transaction code from a pull-down menu of commonly-used or desirable transaction codes. A transaction code is preferably a one to two word description; however, it can also be a number, abbreviation, or other alphanumeric code. As has been previously discussed, there is no limit to the number of transaction codes that can be used and associated with transactions; however, the preferred embodiment allows up to five such codes to be defined. For data structuring purposes, it is desirable to have a “fixed” number of transaction codes established in the system. For each transaction code defined or created in step 1710, it is then necessary to assign or define (step 1720) one or more permissible T code values associated therewith. This corresponds to the screen shots shown in FIGS. 14A through 14F. As with the transaction codes themselves, the T code values are preferably a one to two word description; however, they can also be a number, abbreviation, or other alphanumeric code. As has been previously discussed, there is no limit to the number of T codes values that may be associated with a particular transaction code.

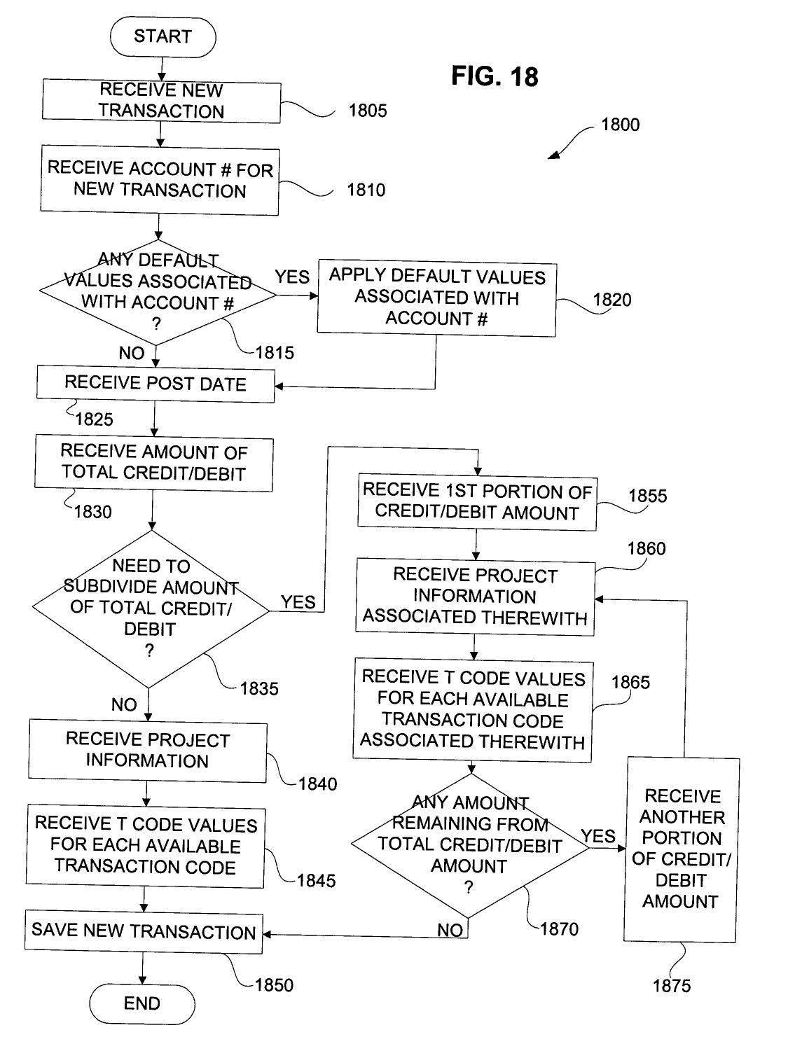

Once transaction codes have been defined and values associated therewith, such transaction codes may be used to track financial data for each transaction input or entered into the accounting system. Turning now to FIG. 18, a preferred method 1800 of inputting or entering a transaction into the accounting system and using transaction codes therewith is illustrated. First, the accounting system receives (step 1810) a new transaction. Typically, this will be the start of a transaction input into the general ledger (such as through a new batch line item in the journal entry, as was shown in FIGS. 15 through 16E); however, transactions may also be input into the system through accounts payable, accounts receivable, or other conventional transaction entry point in an accounting system. An account (typically, using its account number) is then associated with (step 1810) the transaction. The system then determines (step 1815) if there are any default values associated with the identified account. For example, as was briefly discussed in association with FIG. 5, an account will typically have an associated description and may also have default projects, transaction codes, and T code values associated therewith. If so, then the system will automatically apply or associate (step 1820) such default values with the transaction. This typically results in the “pre-population” of the relevant data fields associated with the transaction, such as the data fields shown, for example, in FIGS. 16A and 16B. The transaction then receives or is assigned (step 1825) a posting date for when the transaction will be “posted” to the relevant account database. The total amount of the transaction, whether a debit or a credit, is then input into or received by (step 1830) the system.

Still with reference to FIG. 18, the system then determines or is instructed (step 1835) whether the total amount of the transaction needs to be subdivided by project and/or any transaction code. If the total amount does not need to be subdivided, then a project is associated (step 1840) and T code values for one or more transaction codes are associated S (step 1845) with this transaction for the total amount. Finally, the transaction is saved (step 1850) into the system for further processing or posting at the relevant time.

If the system determines or is instructed (in step 1835) that the total amount does need to be subdivided, then a first portion of the total amount of the transaction, whether a debit or a credit, is then input into or received by (step 1855) the system. A project is associated (step 1860) and T code values for one or more transaction codes are associated (step 1865) with this portion of the total amount of the transaction. Next, the system determines (step 1870) whether there is any remaining amount of the total transaction amount that still needs to be allocated. If so, another portion of the total amount is then input or is received (step 1875) by the system. A project and T code values for one or more transaction codes are then associated with this other portion of the total amount of the transaction (steps 1860 and 1865 repeated). The system again determines (step 1870) whether there is any remaining amount of the total transaction amount that still needs to be allocated. If not, the transaction is saved (step 1850) into the system for further processing or posting at the relevant time.

### Financial Report of the Present Invention

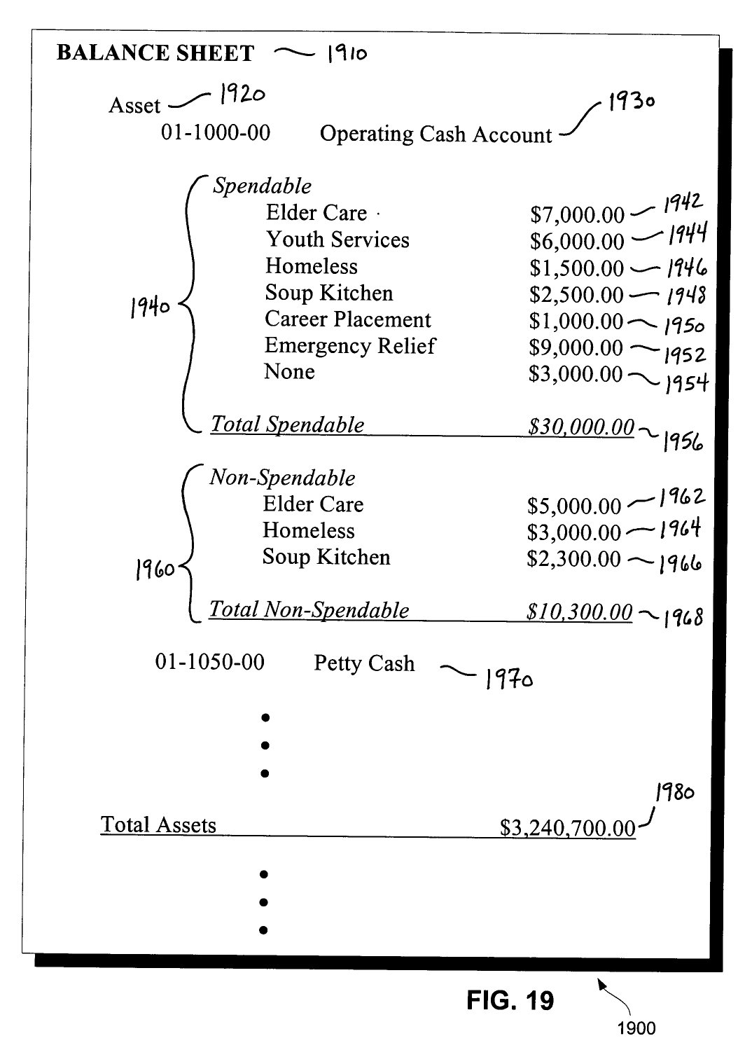

Turning now to FIG. 19, a portion of one exemplary financial report 1900 that takes advantage of the use of transactions codes is illustrated. The financial report 1900 includes an asset portion 1920 of a balance sheet 1900 with one primary account, Operating Cash Account, 1930 displayed. The account 1930 is subdivided into two main sections 1940, 1960, corresponding to the two currently-permissible values for transaction code 2 (spendable/non-spendable), namely, “spendable” and “non-spendable.” Within each of these sections, the amounts are further sub-divided by the currently-permissible values for transaction code 1 (mission) that have a none-zero value, namely, elder care 1942, youth services 1944, homeless 1946, soup kitchen 1948, career placement 1950, emergency relief 1952, and none 1954 associated with the spendable 1940 transaction code; and elder care 1962, homeless 1964, and soup kitchen 1966 associated with the non-spendable 1960 transaction code. The total spendable amount 1956 and the total non-spendable amount 1968 are also shown. The description line for the next account, Petty Cash, 1970 is shown but specific information and transaction codes associated therewith and all remaining accounts in the financial report 1900 have been redacted, except for the total assets line 1980. It should be understood that this is just one example of many arrangements in which transaction codes may be useful in segregating financial information across accounts and projects.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discemable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. In a computerized accounting system having a plurality of accounts associated therewith, each account having one or more account segments defining an account number, an improved method of tracking transactional information associated with accounts without the need for adding further account segments to the accounts, comprising the steps of:
defining at least one transaction code, the transaction code having a plurality of permissible values associated therewith;
receiving an input defining a transaction, the transaction having an amount;
associating the transaction with one of the plurality of accounts;
associating the transaction with a project;
associating the transaction with the at least one transaction code; and
assigning a value from the plurality of permissible values to the at least one transaction code.

2. The method of claim 1 wherein the at least one transaction code is definable by a user of the computerized accounting system.

3. The method of claim 1 wherein the at least one transaction code is pre-defined.

4. The method of claim 1 wherein the at least one transaction code represents one of the group of: a mission, a region, a department, a location, a performance, and a spendable/non-spendable indicator.

5. The method of claim 1 wherein at least one of the plurality of permissible values associated with the at least one transaction code is definable by a user of the computerized accounting system.

6. The method of claim 1 wherein at least one of the plurality of permissible values associated with the at least one transaction code is pre-defined.

7. The method of claim 1 wherein the transaction is a credit or a debit.

8. The method of claim 1 further comprising the step of generating a financial report including the transaction, the financial report displaying the value of the transaction code associated with the transaction.

9. The method of claim 1 wherein the transaction is associated with the transaction code and the value of the transaction code is assigned based on the association of the transaction with one of the plurality of accounts.

10. In a computerized accounting system having a plurality of accounts associated therewith, each account having one or more account segments defining an account number, an improved method of tracking transactional information associated with accounts without the need for adding further account segments to the accounts, comprising the steps of:
receiving an input defining a transaction, the transaction having an amount;
associating the transaction with one of the plurality of accounts;
for at least two portions of the amount:
associating each respective portion with a plurality of transaction codes; and
assigning a value to each transaction code.

11. The method of claim 10 further comprising the step of defining the transaction codes, each transaction code having a plurality of permissible values associated therewith.

12. The method of claim 11 wherein at least one of the plurality of permissible values associated with at least one transaction code is definable by a user of the computerized accounting system.

13. The method of claim 11 wherein at least one of the plurality of permissible values associated with at least one transaction code is pre-defined.

14. The method of claim 10 wherein the portions add up to the amount.

15. The method of claim 10 wherein the portions are equal.

16. The method of claim 10 wherein each portion is associated with the same transaction codes.

17. The method of claim 16 wherein the values assigned to the transaction codes of each portion are different.

18. The method of claim 10 wherein each portion is associated with different transaction codes.

19. The method of claim 10 wherein at least one of the transaction codes is definable by a user of the computerized accounting system.

20. The method of claim 10 wherein at least one of the transaction codes is pre-defined.

21. The method of claim 10 wherein at least one of the transaction codes represents one of the group of: a mission, a region, a department, a location, a performance, and a spendable/non-spendable indicator.

22. The method of claim 10 wherein the transaction is a credit or a debit.

23. The method of claim 10 further comprising the step of generating a financial report including the transaction, the financial report displaying the portions of the transaction and the values of the transaction codes associated with each portion.
